(19) United States
(12) Patent Application Publication
(10) Pub. No.: US 2009/0183037 A1
(43) Pub. Date: Jul. 16, 2009

(54) Statistical processing apparatus capable of reducing storage space for storing statistical occurrence frequency data and a processing method therefor

(75) Inventors: Yoshitaka Hamaguchi, Nara (JP); Satoshi Ikada, Nara (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD., Tokyo (JP)

(21) Appl. No.: 12/320,046

(22) Filed: Jan. 15, 2009

(30) Foreign Application Priority Data
Jan. 16, 2008 (JP) 2008-007359
Mar. 4, 2008 (JP) 2008-053195

(51) Int. Cl. G06F 11/00

(52) U.S. Cl. 714/704; 714/E11.001

(57) ABSTRACT

In a network analyzer, a storage stores a set of occurrence frequencies in entire, first and final intervals. An arithmetic processor counts the value while deleting the frequency information based on the stored frequency information. The arithmetic processor determines whether to estimate the occurrence frequency in the interval next to the first interval for the stored frequency information after counting for a predetermined number of data sets or counting the value in each interval. When the determination is true, the difference in occurrence frequency in the first interval and the estimated occurrence frequency are stored as the occurrence frequency in a number, corresponding to the predetermined number—1, of the intervals shifted by one interval. The occurrence frequency in the next interval is estimated based on the set to store the estimated occurrence frequency in the storage as the occurrence frequency of the first interval in the next data sets.

### BACKGROUND OF THE INVENTION

1. Field of the Invention

The present invention relates to a statistical processing apparatus capable of reducing storage space for storing data of statistical occurrence frequency, and more specifically to a statistical processing apparatus for use in, for example, a network management system for counting the occurrence frequency of each value of data to be processed included in a stream of data supplied over a telecommunications network. The present invention also relates to a statistical processing method for use in, for example, a processing method for counting the occurrence frequency of each value in a stream of data supplied over a telecommunications network to obtain statistical frequency information from a count of occurrence frequency.

2. Description of the Background Art

An apparatus for extracting values appearing at a frequency equal to or higher than a certain value from large sequential streaming time-serial data is required in various situations. Such an apparatus, for example, treats IP (Internet Protocol) addresses having errors such as packet loss detected on traffic as a stream of data, and counts the number of the detected errors in each IP address to statistically process the errors. The apparatus is applied to, for example, a monitoring system for using a resultant count to observe traffic to determine an IP address or a path having caused the errors at a rate equal to or higher than a certain value.

When applied to such a case, in order to count errors in the simplest way, such an apparatus can include counters which are provided for each IP address and incremented in response to each error caused, and include memories for storing a resultant count. The apparatus is adapted to, each time having detected an error, increment the counter associated with an IP address on which the error was detected to store the resultant count in the memory.

Well, in general, an IP network has its IP address space enormous. Therefore, in order to count errors in the simplest way through such an apparatus, the apparatus has to have counters which are provided to be equal in number to at least the terminal devices to be monitored that are connected to an IP network, and the corresponding storage space required for recording the counts. In order to satisfy such a least demand, too many counters and large memory space are required.

In such an apparatus, even when searching for a counter related to the frequency equal to or higher than a desired frequency value, it is also required to scan large memory space in order to extract appropriate data of the results stored in the memory. As a result, the more counters, the longer time is needed for searching. As described above, the provision of the counters for every IP address is generally not suitable for practical use.

Methods for improving these points have been proposed. One of the proposed documents is Gurmeet Singh Manku, et al., “Approximate Frequency Counts over Data Streams”, Proceedings of the 28th VLDB Conference, (28th VLDB), pp. 346-357, August 2002. This document discloses a method for appropriately deleting the count for data, i.e. IP address, determined to have an occurrence frequency stochastically lower or falling within a certain error range to thereby count, with small memory space, data appearing at a frequency equal to or higher than a certain value and their frequencies. A count for an IP address is frequency information, and is referred to as a sketch.

Especially, a method described in Section 4.2 “Lossy Counting Algorithm” of Gurmeet Singh Manku, et al., will be simply described. This method is performed, for example, through the following steps in a network analyzer performing a statistical process by a computer, etc.

In step (1), the network analyzer stores N pieces of data or values acquired in each cycle in a stream of data to be counted in a storage area reserved by a storage, where N is a predetermined natural number. Now, the N pieces of data or values is assumed to be divided by the reciprocal number of an allowable error rate ε [%] defining an error range of a frequency. This divided unit is defined as a time interval. Therefore, the number of intervals in one cycle is represented by εN. Each interval is designated with, for example, one integer from one as an interval number in series.

In step (2), the network analyzer starts a process from first data, or first data of an interval number 1 in series. When determining that the data related to the process have a new value, the storage stores the frequency information including an error estimating value Δ represented by a value calculated by subtracting one from the interval number of the interval including the value and the data, and a frequency count f set to one. Meanwhile, when determining that the data or value representing an IP address in the process has already been stored, the storage stores a value calculated by adding one to a frequency count f for the IP address.

In step (3), each time reaching a boundary of the interval, i.e., final data in the interval, the network analyzer determines whether to delete the frequency information representing the data or value having a low frequency count f, based on the following conditions in the storage.

(3.1) If f+Δ≦(current interval number), then data including this frequency count f and this error estimating value A <(current interval number), data including this frequency count f and this error estimating value Δ, in other words, the frequency information is deleted in the storage.

(3.2) The data or value such that the condition (3.1), in other words, the inequality is not satisfied is left in the storage.

Once steps (2) and (3) are repeated to the N-th data or value, the network analyzer is mathematically guaranteed to leave all the data or value representing the frequency count equal to or more than a certain number in the storage, and deletes the data or value having a low frequency count f by the condition (3.1) not to leave the data or value. Therefore, since memory space is necessary only for counting the important data having a high frequency count f, even smaller memory space is sufficient for processing a larger amount of data stream in order to count the occurrence frequency of the required data.

Well, like traffic observation, in applications where data consecutively and endlessly stream and IP addresses active in communication often change, IP addresses frequently appearing in the observed streams of data generally change so often with time. In such cases, from a viewpoint of knowing temporal change in the frequently-appearing IP addresses as close to real-time as possible, processed results are required to be able to be extracted at time intervals as short as possible. From a similar viewpoint, frequently-appearing data are also required to be able to be extracted consecutively without intermittence in traffic observation.

However, in the prior art disclosed by Gurmeet Singh Manku, et al., since one block of processes is completed by N pieces of data or values processed, the processed result can be basically extracted only each time the N pieces of data or values were processed even in the case where frequently-appearing data or values are desired to be consecutively extracted.

Since the number of data pieces (1/ε) in each interval and the number of intervals (εN) are defined on the basis of the allowable error rate ε for N pieces of data or values, it is restrained to shorten the interval by decreasing the N data pieces to be processed as one unit.

If a result from processing in this way is extracted without waiting for a completion of each process on the N pieces of data or values, it is then necessary to shift the starting point of the data or value by positions corresponding to the intended number w of data pieces, and to start the counting process on the respective data or values in parallel from the starting point thus shifted. In this case, the counting process can acquire a extracted result in each process for the w pieces of data. However, since multiple parallel processes require the memory space and data processing capacity used for each process, the enormous resources have to be consumed. This may cause a gap against the purpose of reducing memory space.

Especially, because of the wide possible range of the value of data in a supplied stream of data, it is difficult to keep storing or recording counts for all the values. In addition, for example, time-serial data cannot appropriately be dealt with when data tend to changeably appear with time.

More specifically, it is difficult to consecutively acquire progressive counts without performing respective parallel processes with data having a lower occurrence frequency deleted to reduce the memory space.

### SUMMARY OF THE INVENTION

It is therefore an object of the present invention to provide a statistical processing apparatus capable of reducing memory space for storing data of statistical occurrence frequency while acquiring the statistical occurrence frequency from a count on a stream of data supplied, and a processing method therefor.

In accordance with the present invention, a statistical processing apparatus sets the number of allowable errors represented by the reciprocal of an allowable error rate to be set for a predetermined number of supplied data sets as the number of intervals for delimiting the data, counts an occurrence frequency for a value of each of data pieces in one interval, deletes frequency information for the occurrence frequency lower than a predetermined occurrence frequency each time acquiring the frequency information based on the counting, and acquires the frequency information for the data through a statistical process. The apparatus includes a storage for storing the occurrence frequencies in entire intervals as all of the intervals, and a first one and a final one of the entire intervals as a set of the occurrence frequencies; and an arithmetic processor for counting the occurrence frequency of the value while deleting the frequency information matching a comparison of the stored frequency information. The arithmetic processor determines whether to estimate the occurrence frequency of the value in the interval next to the first interval for the value of the frequency information stored in the storage after counting the predetermined number of the data sets or after counting the value of the data set in each interval. The arithmetic processor is in response to true determination to store in the storage a value calculated by subtracting the occurrence frequency in the first interval from the estimated occurrence frequency as the occurrence frequency in the data sets of a number, corresponding to the predetermined number minus one, of the intervals shifted by one interval. The arithmetic processor estimates the occurrence frequency in the interval next to the first interval based on the set of occurrence frequencies to store the estimated occurrence frequency in the storage as the occurrence frequency of the first interval in the predetermined number of the next data sets shifted by one interval.

Furthermore, a statistical processing apparatus in accordance with the present invention sets the number of allowable errors represented by the reciprocal of an allowable error rate to be set for a predetermined number of data sets in a stream of data supplied in one cycle period as the number of intervals for delimiting data, counting an occurrence frequency of a value for each data piece in one interval, deletes frequency information for the occurrence frequency lower than a predetermined occurrence frequency each time acquiring the frequency information based on the counting, and acquires the frequency information for the data. The apparatus includes a storage for storing the occurrence frequencies in a first one and a final one of the intervals delimited for the data sets, the occurrence frequency for counting the occurrence of each value of the data, and an error estimating value representing a count starting interval of the occurrence frequency for counting the occurrence of each value of the data as a set of the frequency information related to counting; and an arithmetic processor for searching the storage storing the frequency information of the value in the data having an occurrence rate equal to or higher than a predetermined occurrence rate in the cycle period, processing the frequency information in the storage through addition, delete and modification, setting, after processing the first data set, the data set shifted by one interval as a next cycle each time processing the data for one interval, and performing the addition, delete and modification for the frequency information of the value so as to search for and acquire the frequency information of the value in the data having the occurrence rate equal to or higher than the predetermined occurrence rate for the data set of the next cycle. The arithmetic processor further includes an acquisition processor for acquiring the value of the data included in a stream of data; a counting processor for newly adding the frequency information for the acquired value in response to the absence of the value for the supplied data, and adding the occurrence frequency of the frequency information for the acquired value in response to the presence of the value to update the occurrence frequency; an intra-interval process number determiner for counting the number of processes for the data from the first data in each interval to store the count in the storage, and to determine whether to reach an interval boundary based on the stored number of the processed data in the interval; a process number determiner for counting the number of the processes for the data from the start of the processes to determine whether or not the number of data sets less than the predetermined number has been processed on the basis of the number of the processed data stored in the storage; a count determination processor for deleting the frequency information having the occurrence frequency lower than the predetermined occurrence frequency in the data for the number of the processed intervals based on the occurrence frequency of the value and the error estimating value in the data set after processing the data acquired in one interval; and a frequency arithmetic processor for adjusting the occurrence frequency by the counting processor based on the error estimating value of each value for the data set in the first cycle stored in the storage, associated with the end of process of the counting processor and the count determination processor, determining whether to estimate the occurrence frequency of the value in the interval next to the first interval, storing, in response to the true determination, a value calculated by subtracting the occurrence frequency in the first interval from the estimated occurrence frequency in the storage as the occurrence frequency in the data sets for a number, corresponding to the predetermined number minus one, of intervals shifted by one interval, and estimating the occurrence frequency in the interval next to the first interval based on one set of the occurrence frequencies to store this estimated occurrence frequency in the storage as the occurrence frequency of the first interval in the next data sets for the predetermined number of intervals shifted by one interval. The arithmetic processor consecutively processes the inputted data treated as data inputted from the first data of the final interval in the next cycle.

Furthermore, a statistical processing method in accordance with the present invention sets the number of allowable errors represented by the reciprocal of an allowable error rate to be set for a predetermined number of supplied data sets as the number of intervals for delimiting the data, counts an occurrence frequency for a value of each data piece in one interval, deletes frequency information for the occurrence frequency lower than a predetermined occurrence frequency each time acquiring the frequency information based on the counting, and acquiring the frequency information for the data through a statistical process. The method includes a first step of determining whether to require to estimate the occurrence frequency in the interval next to the first interval in a divided data set for each value of the frequency information stored in a storage after counting for the data set and after counting the value in each interval, and a second step of storing the occurrence frequency calculated by subtracting the occurrence frequency in the first interval from the acquired occurrence frequency for the data set in the storage as the occurrence frequency through a counting process in the data of a number, corresponding to the predetermined number minus one, of the intervals shifted by one interval based on the occurrence frequency in the first interval, the occurrence frequency in the final interval in the divided data set, and the occurrence frequency in the data sets stored in the storage as the frequency information where a determination in the first step is true, and estimating the occurrence frequency in the next interval to store the estimated occurrence frequency in the storage as the occurrence frequency of the first interval in the next data set shifted by one interval.

In a statistical processing apparatus in accordance with the present invention, a storage stores occurrence frequencies in entire intervals, and a first interval and a final interval as a set of the occurrence frequencies, and an arithmetic processor counts the occurrence frequency of the value while deleting the frequency information matching a comparison of the stored frequency information. The arithmetic processor determines whether to estimate the occurrence frequency of the value in the interval next to the first interval for the value of the frequency information stored in the storage after counting a predetermined number of the data sets or after counting the value of the data set in each interval, stores in the storage, in response to the true determination, a value calculated by subtracting the occurrence frequency in the first interval from the estimated occurrence frequency as the occurrence frequency in the data sets of a number, corresponding to the predetermined number minus one, of the intervals shifted by one interval, and estimates the occurrence frequency in the interval next to the first interval based on the set of the occurrence frequencies to store the estimated occurrence frequency in the storage as the occurrence frequency of the first interval in the predetermined number of the next data sets shifted by one interval. While reducing the memory space and data processing capacity required for the counting and statistical processes, the statistical frequency information can be extracted and acquired at a much shorter time interval than the conventional art that can acquire the occurrence frequency only after the process for the predetermined number of data sets.

Furthermore, in a statistical processing apparatus in accordance with the present invention, a storage stores the occurrence frequencies in a first interval and a final interval of the intervals delimited for the data sets, the occurrence frequency for counting the occurrence of each value of the data, and an error estimating value representing a count starting interval of the occurrence frequency for counting the occurrence of each value of the data as a set of the frequency information related to counting. An arithmetic processor searches the storage storing the frequency information of the value in the data having an occurrence rate equal to or higher than a predetermined occurrence rate in the cycle period, processes the frequency information in the storage through addition, delete, and modification, sets, after processing the first data set, the data set shifted by one interval as a next cycle each time processing the data for one interval, and performs the addition, delete and modification for the frequency information of the value so as to search for and acquire the frequency information of the value in the data having the occurrence rate equal to or higher than the predetermined occurrence rate for the data set of the next cycle. Furthermore, in the arithmetic processor, an acquisition processor acquires the value of the data included in the stream of data. A counting processor newly adds the frequency information for the acquired value in response to the absence of the value for the supplied data, and adds the occurrence frequency of the frequency information for the acquired value in response to the presence of the value to update the occurrence frequency. An intra-interval process number determiner counts the number of processes for the data from the first data in each interval to store the count in the storage, and to determine whether to reach an interval boundary based on the stored number of the processed data in the interval. A process number determiner counts the number of the processes for the data from the start of the processes to determine whether or not the number of data sets less than the predetermined number has been processed on the basis of the number of the processed data stored in the storage. A count determination processor deletes the frequency information having the occurrence frequency lower than the predetermined occurrence frequency in the data for the number of the processed intervals based on the occurrence frequency of the value and the error estimating value in the data set, after processing the data acquired in one interval. A frequency arithmetic processor adjusts the occurrence frequency by the counting processor based on the error estimating value of each value for the data set in the first cycle stored in the storage, associated with the end of process of the counting processor and the count determination processor, determines whether to estimate the occurrence frequency of the value in the interval next to the first interval, stores in the storage, in response to the true determination, a value calculated by subtracting the occurrence frequency in the first interval from the estimated occurrence frequency as the occurrence frequency in the data sets for the number, corresponding to the predetermined number minus one, of intervals shifted by one interval, and estimates the occurrence frequency in the interval next to the first interval based on one set of the occurrence frequencies to store this estimated occurrence frequency in the storage as the occurrence frequency of the first interval in the next data sets for the predetermined number of intervals shifted by one interval. The arithmetic processor consecutively processes the inputted data treated as data inputted from the first data of the final interval in the next cycle. While reducing the memory space and data processing capacity required for the counting and statistical processes, the statistical frequency information can be extracted and acquired at a much shorter time interval than the conventional art that can acquire the occurrence frequency only after the process for the predetermined number of data sets.

Furthermore, in a statistical processing method in accordance with the present invention, a first step determines whether to require to estimate the occurrence frequency in the interval next to the first interval in the divided data set for each value of the frequency information stored in a storage after the count for the data set and after counting the value in each interval, and a second step stores the occurrence frequency calculated by subtracting the occurrence frequency in the first interval from the acquired occurrence frequency for the data set in the storage as the occurrence frequency through a counting process in the data of the number, corresponding to the predetermined number minus one, of the intervals shifted by one interval based on the occurrence frequency in the first interval, the occurrence frequency in the final interval in the divided data set, and the occurrence frequency in the data sets stored in the storage as the frequency information where a determination in the first step is true, and estimates the occurrence frequency in the next interval to store the estimated occurrence frequency in the storage as the occurrence frequency of the first interval in the next data set shifted by one interval. A count result of the data having a low statistical occurrence frequency can be deleted to thus reduce the memory space for storing count results for the counting.

### BRIEF DESCRIPTION OF THE DRAWINGS

The objects and features of the present invention will become more apparent from consideration of the following detailed description taken in conjunction with the accompanying drawings in which:

FIG. 1 is a schematic block diagram showing a configuration of a network analyzer to which a statistical processing apparatus in accordance with an embodiment of the present invention is applied;

FIGS. 2A-2D show examples of frequency information stored into a sketch memory shown in FIG. 1;

FIG. 3 is a conceptual diagram on time axis showing data acquisition applied to a statistical process in the network analyzer shown in FIG. 1;

FIGS. 4 and 5 are a main flowchart showing operational steps of the statistical process in the network analyzer shown in FIG. 1;

FIG. 6 is a flowchart of a subroutine showing arithmetic steps for an occurrence frequency in the flow shown in FIG. 4;

FIG. 7 is a graph conceptually showing the estimation for the occurrence frequency in the network analyzer shown in FIG. 1;

FIG. 8 is a schematic block diagram showing a configuration of an arithmetic processor included in a network analyzer to which a statistical processing apparatus in accordance with an alternative embodiment of the present invention is applied;

FIG. 9 is a flowchart showing operational steps newly added to the main flowchart in the network analyzer shown in FIG. 8;

FIG. 10 is a schematic block diagram showing a configuration of an acquisition processor included in the arithmetic processor of the network analyzer to which applied is the statistical processing apparatus in accordance with the alternative embodiment of the present invention;

FIG. 11 is a schematic block diagram showing a configuration of a counting processor included in the arithmetic processor shown in FIG. 10;

FIG. 12 shows how to divide a stream of data counted by the counting processor shown in FIG. 11;

FIG. 13 shows an exemplary format for containing a resultant count in prior art;

FIG. 14 shows steps for a counting process by a counting function block shown in FIG. 11;

FIG. 15A shows an example of count result table containing a result of the counting process by the counting function block shown in FIG. 11;

FIG. 15B shows an example of a threshold value position table containing a result of the counting process by the counting function block shown in FIG. 11;

FIG. 16A shows a range of the counting process by the counting function block shown in FIG. 11;

FIG. 16B shows the delete of a resultant count in the initial stage, in the result counted by the counting function block shown in FIG. 11;

FIG. 16C shows a process for shifting intervals by one interval after the delete shown in FIG. 16B;

FIG. 16D shows the delete of a count in the initial stage satisfying a condition after the process shown in FIG. 16C;

FIG. 17A shows an example of count result table before the delete, acquired by the count through the counting function block shown in FIG. 11;

FIG. 17B shows an example of threshold value position table before the delete, acquired by the count through the counting function block shown in FIG. 11;

FIG. 17C shows an example of count result table after the delete, acquired by the count through the counting function block shown in FIG. 11;

FIG. 17D shows an example of threshold value position table after the delete, acquired by the count through the counting function block shown in FIG. 11;

FIG. 18 is a schematic block diagram showing a configuration of a packet collector included in an input interface circuit of a network analyzer to which applied is a statistical processing apparatus in accordance with another alternative embodiment of the present invention; and

FIG. 19 is a schematic block diagram showing a configuration of the packet collector included in the counting processor of the network analyzer to which the statistical processing apparatus in accordance with the other alternative embodiment of the present invention is applied.

### DESCRIPTION OF THE PREFERRED EMBODIMENTS

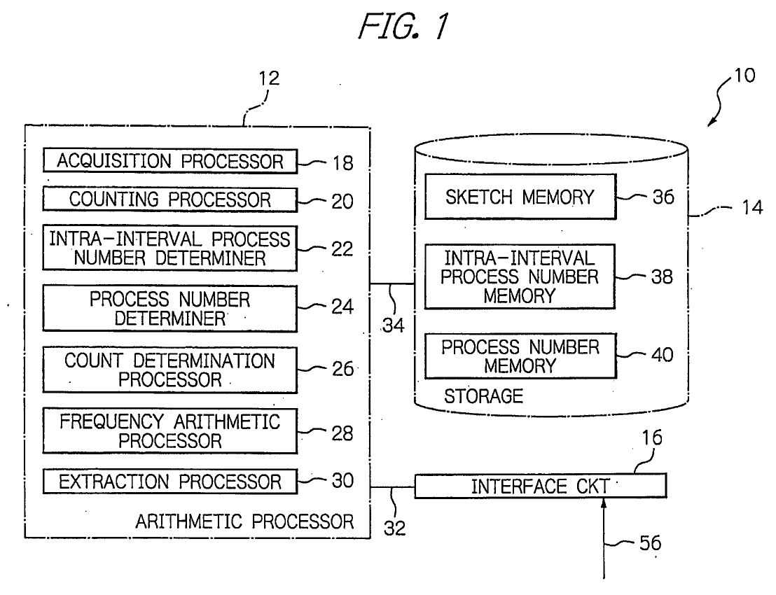

Reference will be made to accompanying drawings to describe in detail a statistical processing apparatus in accordance with preferred embodiments of the present invention. With reference first to FIG. 1, the statistical processing apparatus in accordance with an illustrative embodiment of the present invention is directed to a network analyzer 10. The network analyzer 10 is adapted to deal with occurrence frequencies over the entire time intervals including the first and final intervals as a set of data of occurrence frequency to store the data in a storage 14, to count the occurrence frequency of values by an arithmetic processor 12 while deleting frequency information appropriate for a comparison made with respect to the stored frequency information, the arithmetic processor 12 determining whether to estimate the occurrence frequency of a value in the interval next to the first one for that value of the frequency information stored in the storage 14 after a completion of counting for a predetermined number of data sets or each time a completion of counting the values of a data set in an interval, to store, when the determination is true, a value calculated by subtracting the occurrence frequency in the first interval from the estimated occurrence frequency in the storage 14 as the occurrence frequency in the data sets corresponding to the intervals the number of which is equal to the predetermined number—1 and which are shifted by one interval, and to estimate the occurrence frequency in the interval next to the first one based on the set of occurrence frequencies to store the estimated occurrence frequency in the storage 14 as the occurrence frequency of the first or top interval in a next predetermined number of data sets shifted by one interval. While reducing the memory space and data processing capacity of the system required for the counting and statistical processes, the statistical frequency information can be extracted and acquired at a much shorter time interval than the conventional art that can merely acquire the occurrence frequency only after the process for a predetermined number of data sets.

More specifically, the network analyzer 10 deals, as a set of data, with data of occurrence frequencies in the first and final ones of the intervals delimited for data sets, an occurrence frequency representing a count of the occurrence of each value of the data, and an error estimating value representing a count starting interval of that occurrence frequency representing the count of the occurrence of the value of the data, and stores the set of data in the storage 14 as frequency information related to counting. The arithmetic processor 12 searches the storage 14 storing the frequency information of the value in the data having an occurrence rate equal to or higher than a predetermined occurrence rate in one cycle period. The processor 12 processes the frequency information in the storage through addition, delete, and modification. The processor 12, after having performed those processes on the first data set, sets the data set shifted by one interval as a next cycle each time it processes the data for one interval, and performs the addition, delete and modification for the frequency information of the value for the data set of the next cycle so as to search for and acquire the frequency information of the value in the data having the occurrence rate equal to or higher than the predetermined occurrence rate. When the arithmetic processor 12 performs those processes, an acquisition processor 18 acquires the value of the data included in the stream of data, and a counting processor 20 newly adds the frequency information for the acquired value when no value is available for the supplied data and adds the occurrence frequency of the frequency information for the acquired value when the value is available to update the occurrence frequency. An intra-interval process number determiner 22 counts the number of processes for the data from the first data in each interval to store a resultant count in the storage 14 and to determine whether to reach an interval boundary based on the stored number of the processed data in the interval. A process number determiner 24 counts the number of the processes for the data from the start of the processes to determine whether or not the number of data sets less than the predetermined number has been processed on the basis of the number of the processed data stored in the storage 14. A count determination processor 26 deletes, after processing the data acquired in one interval, the frequency information having the occurrence frequency lower than the predetermined occurrence frequency in the data for the number of the processed intervals based on the occurrence frequency of the value and the error estimating value in the data set. A frequency arithmetic processor 28 adjusts the occurrence frequency by the counting processor 20 based on the error estimating value of each value for the data set in the first cycle stored in the storage 14, associated with the end of process of the counting processor 20 and the count determination processor 26. The processor 28 determines whether to estimate the occurrence frequency of the value in the interval next to the first interval. When the determination is true, the processor 28 stores a value calculated by subtracting the occurrence frequency in the first interval from the estimated occurrence frequency in the storage 14 as the occurrence frequency in the data sets corresponding to the intervals the number of which is equal to the predetermined number—1 and which are shifted by one interval, and estimates the occurrence frequency in the interval next to the first one based on one set of occurrence frequencies to store this estimated occurrence frequency in the storage 14 as the occurrence frequency of the first interval in the next data sets for the predetermined number of intervals shifted by one interval. The arithmetic processor 14 consecutively processes the inputted data treated as data inputted from the first data of the final interval in the next cycle. While reducing the memory space and data processing capacity of the system required for the counting process and the statistical process, the statistical frequency information can thus be extracted and acquired at a much shorter time interval than the conventional art that can merely acquire the occurrence frequency only after the process for a predetermined number of data sets.

In the instant embodiment, the statistical processing apparatus of the present invention is applied to the network analyzer 10. Elements or parts not directly relevant to the understanding of the present invention will be omitted from the descriptions and drawings.

As shown in FIG. 1, the network analyzer 10 includes the arithmetic processor 12, the storage 14, and an interface circuit 16. The arithmetic processor 12 has a processing function based on data to be processed. The arithmetic processor 12 in this embodiment performs a statistical process to extract as a result a value having a occurrence rate equal to or higher than a value s [%] in a predetermined number N of pieces of data, each time the counting process is performed for a 1/ε pieces of new data.

The arithmetic processor 12 further includes the data acquisition processor 18, the counting processor 20, the intra-interval process number determiner 22, the process number determiner 24, the count determination processor 26, the frequency arithmetic processor 28, and an extraction processor 30.

The data acquisition processor 18 has a function to acquire a value of data in a received signal, i.e. a stream of data. The data acquisition processor 18 determines and acquires the value of data in a received signal 32 supplied through the interface circuit 16. Signals or data are designated with reference numerals for connection lines on which they appear.

The counting processor 20 has a function to acquire the frequency information through a data addition process and an interval frequency addition process based on the determined and acquired value to supply the acquired frequency information to the storage 14 so as to add and update the acquired frequency information. More specifically, the counting processor 20 newly adds the frequency information for the acquired value in response to the absence of the value for the supplied data, and adds the occurrence frequency of the frequency information for the acquired value in response to the presence of the value to update the occurrence frequency.

The data addition process is to newly add the frequency information stored in the storage 14. The interval frequency addition process is to increase the value of a final interval frequency yₙ stored in the storage 14 to acquire the frequency information. The counting processor 20 supplies the acquired frequency information 34 to the storage 14 based on the value acquired by the data acquisition processor 18 so as to update the frequency information.

The intra-interval process number determiner 22 has a function to count the number of processes for the data from the first data in each interval to store the count in the storage 14, and to determine whether to reach an interval boundary based on the stored number of processed data in the interval. The intra-interval process number determiner 22 supplies a resultant count value 34 to the storage 14 to determine whether to reach the interval boundary based on the resultant count 34.

The process number determiner 24 has a function to count the number of the processed data from the start of the processes to determine whether to have processed the number of data equal to or more than the value N based on the number of the processed data stored in the storage 14. The process number determiner 24 determines whether or not the pieces of data fewer than the value N have been processed based on the stored number of processed data.

The count determination processor 26 has a function to update and delete the frequency information through a frequency addition process and a low-frequency data deletion process. The count determination processor 26, after processing the data acquired in one interval, deletes the frequency information for the occurrence frequency equal to or lower than the predetermined occurrence frequency in the data for the number of the processed intervals based on the occurrence frequency of the value and the error estimating value in the data set.

The frequency addition process determines the final frequency count f based on the end of data processing in each interval boundary. The low-frequency data deletion process deletes the frequency information having a low occurrence frequency in the storage 14. The count determination processor 26 updates and deletes the frequency information.

The frequency arithmetic processor 28 has a function to calculate the occurrence frequency in the first interval based on the fixed frequency information derived from the N pieces of data. Particularly, as described below, when the N pieces of data are treated as one cycle, this embodiment properly calculates the occurrence frequency in the first interval of the next cycle. The occurrence frequency is an approximate value.

The frequency arithmetic processor 28 adjusts the occurrence frequency by the counting processor 20 based on the error estimating value of each value for the data set in the first cycle stored in the storage 14 associated with the end of process of the counting processor 20 and the count determination processor 26, and then determines whether to estimate the occurrence frequency of this value in the interval next to the first interval. In response to the true determination, a value calculated by subtracting the occurrence frequency in the first interval from the estimated occurrence frequency is stored in the storage 14 as an occurrence frequency in the data set corresponding to the intervals the number of which is equal to the predetermined number—1 and which are shifted by one interval. Then, the occurrence frequency in the interval next to the first interval is estimated on the basis of one set of occurrence frequencies to be stored in the storage 14 as the occurrence frequency of the first interval in the next data set for the predetermined number of intervals shifted by one interval.

The extraction processor 30 has a function to extract the frequency count as the result of each value based on the frequency information stored in the storage 14 to display this frequency count on a display monitor, not shown.

In the illustrative embodiment, the statistical process using this function searches and extracts the occurrence frequency having an occurrence rate equal to or higher than the value s [%] in the N pieces of data.

Now, the occurrence frequency having its occurrence rate equal to or higher than a value s−ε [%] actually is extracted because of the allowable error rate ε. In other words, if f≧(s−ε)N, then the frequency count f is extracted as the occurrence frequency. More specifically, when the occurrence rate s=1 [%], and the allowable error rate ε=0.1 [%], the purpose of the network analyzer 10 is to extract the data having its occurrence rate equal to or higher than the value s [%], but there is a possibility that the data actually having the occurrence rate equal to or higher than 0.9 [%] is extracted because of the allowable error rate ε of 0.1 [%].

Each of the components of the arithmetic processor 12 may be implemented by a separate, specialized device, i.e., specific hardware. However, for example, a computer, including a CPU (Central Processing Unit) of course, may be generally used as hardware to implement the processing steps performed by each processor in the arithmetic processor 12 through software or firmware by programming these steps in advance. Then, the arithmetic processor 12 performs the pre-programmed steps to process the counting, thus performing the statistical process. This statistical process stores the acquired data 34 in the storage 14.

The storage 14 has a function to store data. The storage 14 in this embodiment temporarily or rather permanently stores data or values such as the frequency information, acquired by the process in the arithmetic processor 12. Specifically, the storage 14 may be implemented by semiconductor devices such as a RAM (Random Access Memory) or a storage having a large storage capacity such as an HDD (Hard Disk Drive).

The storage 14 functions to store results acquired in the processes by the arithmetic processor 12 and to delete the stored result in response to a supplied control signal. The storage 14 includes a sketch memory 36, an intra-interval process number memory 38, and a process number memory 40. The sketch memory 36 is adapted to store the frequency information 34 from the data acquisition processor 18, and delete the stored frequency information 34 in response to a control signal 34 from the count determination processor 26. The sketch memory 36 provides the frequency information satisfying a condition in response to the control signal 34 on the search of the extraction processor 30.

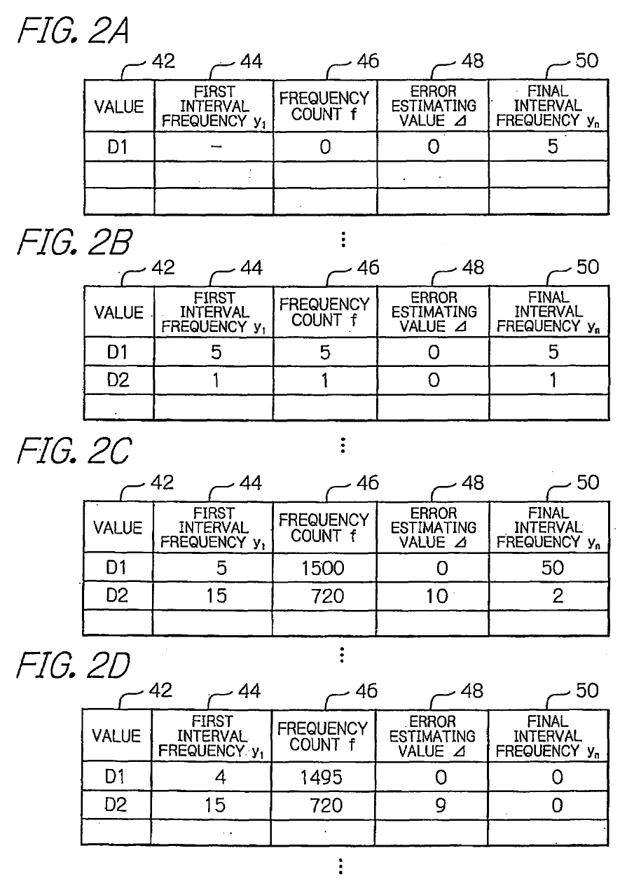

FIGS. 2A to 2D show examples of the frequency information stored in the sketch memory 36. The sketch memory 36 stores the frequency information including a set of items of a value 42 of occurring data, the occurrence frequency, i.e. a frequency count f 46 representing an occurrence count, an error estimating value Δ 48 of the occurrence frequency, the first interval frequency y₁ 44, and the final interval frequency yₙ 50 in the form of data table. The frequency information is added, updated, or deleted by the process in the counting processor 20. Steps of the statistical process by the network analyzer 10 will be described below with reference to FIGS. 2A to 2D.

The intra-interval process number memory 38 stores the number of data processed in the current interval based on the process in the intra-interval process number determiner 22.

The process number memory 40 stores the number of processed data and the number of processed interval boundaries, i.e. intervals from the start of the statistical process based on the process in the process number determiner 24. The stored number of interval boundaries for the current interval, when having its interval number equal to five, for example, is four, calculated by subtracting one from this interval number. Then, the processes for all the data in the current interval is determined to be finished, and then the value, five, is stored.

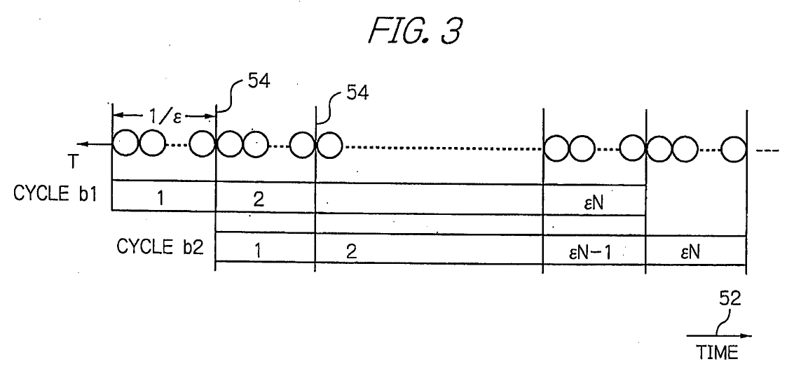

Now, FIG. 3 shows the concept of data in the statistical process. The circles in the figure indicate respective pieces of the data. The data in FIG. 3 are to be processed from the left in chronological order. Therefore, time progresses in the direction of an arrow 52. As described above, it is assumed that the N pieces of data are virtually divided by the value 1/ε into the intervals, and that each boundary of the intervals is referred to as an interval boundary 54. Each interval is designated with a number b starting from unity in sequence.

For example, if N=100000, the number εN of intervals is equal to (0.1/100)×100000=100. Therefore, 100,000 pieces of data are divided by 1,000 into 100 intervals.

The network analyzer 10 in the instant illustrative embodiment, after processing the N pieces of data, performs statistical processes for searching and extracting a value having its occurrence rate equal to or higher than a predetermined occurrence rate each time finishing a counting process in the interval consisting of the 1/ε pieces of data as a unit less than the value N. In FIG. 3, after the process for extracting a value having its occurrence rate equal to or higher than the predetermined occurrence rate in the N pieces of data in a cycle b1, the 1/ε pieces of data are newly processed, and then the process for extracting the value is performed in the N pieces of data in a cycle b2 under the similar condition. In this way, each time newly acquiring the 1/ε pieces of data, the process for extracting a value matching the condition is continued.

At this time, since the N pieces of data shifted by one interval do not include the occurrence frequency in one displaced interval compared with the N pieces of data before shifted by one interval, the occurrence frequency in this displaced interval has to be subtracted. However, storing the occurrence frequency in each interval causes an increase in memory space to significantly impair the effect of reducing the memory space. This is caused since the memory space for each of the data pieces needs to be basically prepared in order to store each occurrence frequency in the plural (εN) intervals.

Thus, the network analyzer 10 in this embodiment, when determining that subtraction for the occurrence frequency is required, for example, when not deleting the frequency information because of the high occurrence frequency, approximately estimates the occurrence frequency in the second interval as the first interval in the N pieces of data shifted by one interval based on the occurrence frequency y₁ of the first interval and the occurrence frequency yₙ of the final interval as the εN-th interval in the N pieces of data.

Now, the instant embodiment uses an expression of quadratic curve to estimate the occurrence frequency. This can estimate the occurrence frequency for each value in the N pieces of data each time finishing the process in one interval after the εN-th interval to extract this result.

Such a principle for extracting by the network analyzer 10 will be described with respect to the cycles b1 and b2 in FIG. 3. When the result of the frequency count f for the N pieces of data in the first to εN-th intervals of the cycle b1 has been already acquired by the process, this result also includes the reflection of the result in the first to (εN−1)-th intervals of the cycle b2. In addition, the result in the first to (εN−1)-th intervals of the cycle b2 will be acquired by merely processing the value in the next interval.

However, at this time, the occurrence frequency in the first interval of the cycle b1 may be included extra. Thus, the occurrence frequency in the first interval of the cycle b1 is subtracted from the result processed in the first to εN-th intervals of the cycle b1 to set this resulting value as the result processed in the first to (εN−1)-th intervals of the cycle b2. In addition, in order to continue such a process, this embodiment properly estimates the approximate occurrence frequency in the first interval of the cycle to subtract this occurrence frequency.

Returning to FIG. 1, the interface circuit 16 has a function to receive a signal including data to be processed from an external device or circuit to convert the format of the received signal. The interface circuit 16 receives a received signal 56 from the exterior to supply the received data 32 to the arithmetic processor 12.

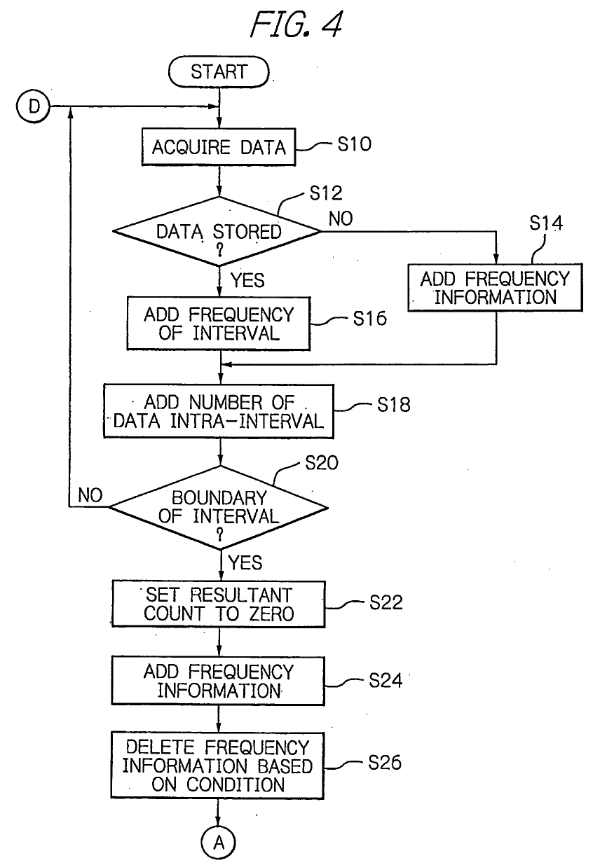

Next, it will be described with reference to FIGS. 4, 5 and 6 how the statistical processing apparatus applied to the arithmetic processor 12 of the network analyzer 10 performs operational steps. The examples of frequency information shown in FIGS. 2A to 2D are properly used for the description.

First, the received signal 56 including data is received by the interface circuit 16 to convert the data in format processable by the arithmetic processor 12. The data 32 converted by the interface circuit 16 is supplied to the data acquisition processor 18 of the arithmetic processor 12. The value of the acquired data is determined through the data acquisition process in the data acquisition processor 18 (Step S10).

Next, it is determined whether or not the determined value as the frequency information is already stored (Step S12). The counting processor 20, for example, right after the start of the process, when determining that the frequency information is not stored in the sketch memory 36 (NO), progresses the step to a frequency information addition process (to Step S14). Meanwhile, when determining that design items related to this value are already stored (YES), the step progresses to an interval frequency addition process (to Step S16).

Next, the frequency information addition process generates the frequency information related to this data to supply the generated frequency information 34 to the sketch memory 36, and stores the information 34 in the memory 34 (Step S14). More specifically, the counting processor 20 sets the error estimating value Δ in the frequency information to a value b−1 calculated by subtracting one from the interval number b. This process sets, for example, the value b−1 to zero when the interval number is equal to one immediately after the start of the process. The counting processor 20 also sets to one the final interval frequency yₙ which will be a resultant count in the interval. However, at this moment, the frequency count f and the first interval frequency y₁ are not yet determined. After this process, the step proceeds to a counting process for the number of the data processing in the interval (to Step S18).

Next, the interval frequency addition process increments the final interval frequency yₙ by one (Step S16). The intra-interval process number determiner 22 supplies the incremented final interval frequency yₙ 34 to the sketch memory 36 to have the frequency yₙ 34 stored in the memory 36. After this process, the step progresses to the counting process for the number of the data processing in the interval (to Step S18).

The counting process for the number of the data processing in the interval increments by one the number of processed data in the interval stored in the intra-interval process number memory 38 through the intra-interval process number determiner 22 (Step S18).

Next, it is determined whether or not the interval boundary is reached (Step S20) by determining whether or not the number of processed data in the interval is equal to the value 1/ε. When determining that the interval boundary is not reached (NO), the step returns to the data acquisition process.

For example, with reference to FIG. 2A, the steps will be described. An item 42 indicating the value in FIG. 2A shows that the value D1 appears five times in the interval #1. At this moment, the undetermined frequency count f is set to zero, and the first interval frequency y₁ is set to be empty.

When determining that the interval boundary is reached through the intra-interval process number determiner 22 (YES), the step proceeds to Step S22 for resetting the number of processed data in the interval.

The reset process sets the number of processed data in the interval included in the intra-interval process number determiner 22 to zero (Step S22).

Next, the count determination processor 26 determines the frequency count f as a kind of frequency information through the frequency addition process (Step S24). The frequency addition process adds the final interval frequency yₙ after the data processing in the interval to the frequency count f. In addition, the final interval frequency yₙ is set to the first interval frequency y₁ only in the interval including the added frequency information.

Specifically, with respect to the value D1 of the item 42 shown in FIG. 2B, the final interval frequency yₙ equal to five is added to the frequency count f to set the frequency count f in the item 46 as the addition result to 0+5=5. The first interval frequency y₁ in the item 44 is also set to five.

Next, the low-frequency data deletion process deletes the frequency information based on a condition (Step S26). The deletion condition is that the occurrence rate is equal to or lower than the allowable error rate ε [%] from the start of the process to the current interval in the count determination processor 26. The count determination processor 26 searches for a value having its occurrence rate satisfying the deletion condition so as to delete the frequency information related to the searched and acquired value in the sketch memory 36.

As described above, since the number of data pieces in one interval is equal to 1/ε, the occurrence rate is equal to the value ε [%] in the interval with one occurrence of data. Therefore, from the start of the process to the current interval where the process is finished, the frequency information having its occurrence frequency equal to or lower than the current interval number b will be deleted in the sketch memory 36.

In addition, since the low-frequency data deletion process is performed each time the frequency addition process is finished in the interval boundary, for example, the low-frequency data deletion process may have deleted the frequency information in the previous interval. Thus, the low-frequency data deletion process also needs to be in response to the frequency count f having a possibility to have been deleted through the previous low-frequency data deletion process.

The error estimating value Δ in the item 48, as described above, contains the value b−1 calculated by subtracting one from the interval number b when the addition process is performed for the frequency information. It is understood that this error estimating value Δ reflects the counting for data from the interval b to the frequency count f. For example, it is understood that the frequency information stored in the sketch memory 36, when including the frequency count f equal to 20 and the error estimating value Δ equal to 10 related to certain data, the addition process is performed for the frequency information in the interval #11, and the occurrence frequency from this interval is equal to 20. In addition, this means that the counting for data before the interval b−1 is not reflected to the frequency count f.

As described above, when having the averaged occurrence frequency equal to or lower than one in the interval, the frequency information will be deleted. Therefore, the frequency count f (occurrence frequency) is equal to a value b−1=Δ for the final interval frequency yₙ, in other words, the occurrence frequency averagely equal to one in the intervals up to the interval number b−1. In practice, since the final interval frequency yₙ may be averagely equal to or lower than one, the error estimating value Δ will represent the maximum value of the frequency count f having a possibility to have been deleted.

Based on the processing described above, the low-frequency data deletion process deletes the frequency information including the frequency count f and the error estimating value Δ satisfying an inequality, f+Δ≦b, through the count determination processor 26 in the sketch memory 36. This low-frequency data deletion process is performed each time the interval boundary is reached, arranging the frequency information in the sketch memory 36.

For example, in the sketch memory 36 having its state shown in FIG. 2B, the inequality results in 2+0≦1 for the value D1 to leave the frequency information after the process in the interval #1, and results in 1+0≦1 for the value D2 to delete the frequency information.

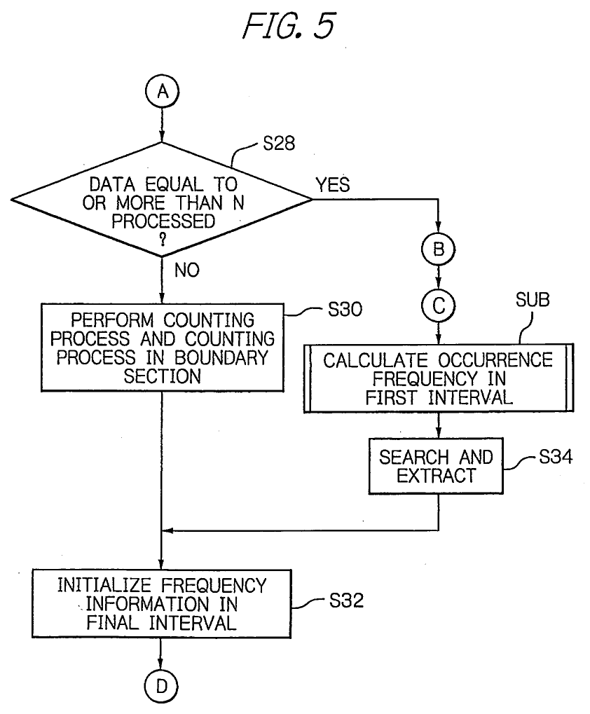

After the low-frequency data deletion process, the step progresses to Step S28 for determining the number of data processing shown in FIG. 5 through a connector A.

Next, it is determined whether or not the number of processed data is lower than the value N (Step S28). In other words, the process number determiner 24 of this embodiment determines whether or not the data in the interval having an interval number less than the value εN are processed based on the number of data processing stored in the process number memory 40.

When determining that the number of processed data is less than the value N (NO), the control proceeds to Step S30, the counting process. Alternatively, when determining that the number of processed data is equal to or more than N, the step progresses to Subroutine SUB, i.e. an approximate process for the occurrence frequency in the first interval through connectors B and C.

The counting process increments the number of data processing stored in the process number memory 40 by the value 1/ε, and further increments the number of interval boundaries representing the number of processed intervals by one (Step S30). After this counting process, the step progresses to Step S32 for initializing the occurrence frequency in the final interval.

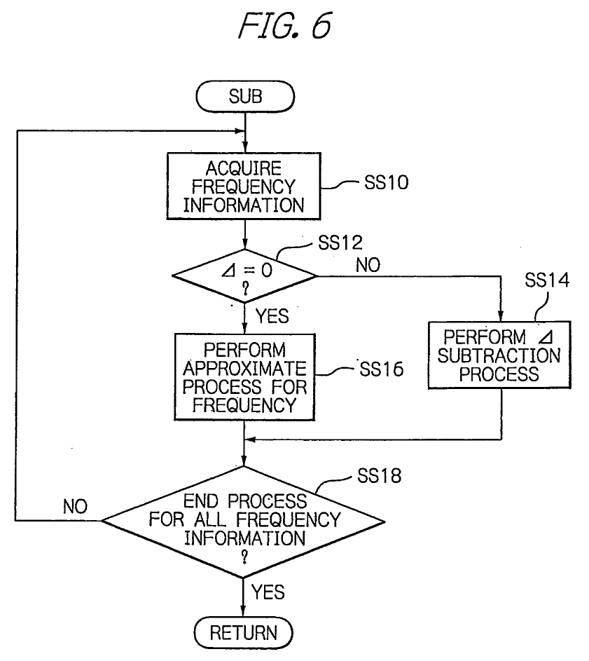

The other process, i.e. the approximate process for the occurrence frequency in the first interval is performed by the frequency arithmetic processor 28 (Subroutine SUB). This approximate process is always performed after the processes for the number of data equal to or more than the value N. The steps in this approximate process will be further described below with reference to FIG. 6.

Next, searching and extracting are performed on the basis of the occurrence frequency stored in the sketch memory 36 (Step S34). The network analyzer 10 continues an occurrence frequency arithmetic process for the first interval after the N-th data to extract the result through the search/extraction processor 30 after each process for the 1/ε pieces of data. After this extraction, the step progresses to Step S32 for initializing the occurrence frequency in the final interval.

The process for initializing the occurrence frequency in the final interval sets the final interval frequency yₙ of the frequency information related to each value to zero in the counting processor 20 (Step S32). Then, the step returns to the data acquisition process through a connector D, consecutively processing the next supplied data as described above.

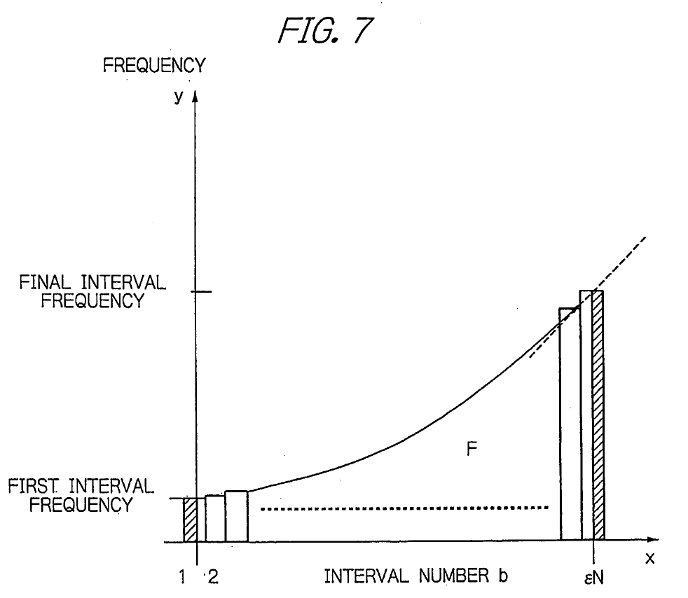

Now, the steps of the arithmetic process for the occurrence frequency in the first interval by the frequency arithmetic processor 28 will be described with reference to FIGS. 6 and 7. First, the frequency information is acquired (Substep SS10). In the acquisition process for the frequency information, the frequency information 34 related to a certain stored value is acquired from the sketch memory 36.

Next, it is determined whether or not the error estimating value Δ is equal to zero (Substep SS12). When the error estimating value Δ is not equal to zero (NO), the step progresses to the subtraction process for the error estimating value Δ (to Substep SS14). Alternatively, when the error estimating value Δ is equal to zero (YES), the step progresses to Substep SS16, a frequency approximate process.

In the subtraction process, since the first interval frequency y₁ is not reflected on the frequency count f, the error estimating value Δ is decremented by one (Substep SS14). This means conceptual shifting of intervals after completing the addition process by one interval. Next, the step progresses to Substep SS18 to determine whether to finish the processes for all the frequency information.

In the frequency approximate process, the frequency arithmetic processor 28 subtracts the first interval frequency y₁ from the frequency count f to calculate the frequency count f from the first to (εN−1)th intervals (data) after the shifting by one interval (Substep SS16). The frequency approximate process also has a function to determine whether or not the frequency count f satisfies the inequality, f≦εN−1.

Now, the estimation of the occurrence frequency in the second interval will be described with reference to FIG. 7. Since the average occurrence frequency in the interval is equal to or less than one when the condition f≦εN−1 is satisfied, the frequency information related to the value is deleted from the sketch memory 36. Alternatively, when the condition f<εN−1 is not satisfied, the approximate occurrence frequency y₂ of the second interval as the occurrence frequency of the first interval after the shifting by one interval is approximately estimated from the current first interval frequency y₁, the final interval frequency yₙ and the frequency count f to calculate the approximate value y₂.

As shown in FIG. 7, the approximate value y₂ is calculated by conceptually assuming a histogram of the occurrence frequencies in the intervals. At this time, it is assumed that the occurrence frequency in the first interval is the first interval frequency y₁, the occurrence frequency in the εN-th interval is the final interval frequency yₙ, and the histogram from the first interval to the εN-th interval is along a certain quadratic curve. It is also assumed that this curve passes through, for example, the points (1, y₁) and (εN, yₙ) on the two-dimensional coordinates. In addition, the curve is defined so that the area surrounded by the lines x=1, x=εN, y=0 and the curve is equal to the region F.

Now, the area F is defined by the expression F=f−(y₁+yₙ)/2, which is modified by subtracting the areas before the center of the first interval and after the center of the final interval from the area represented by the frequency count f. The approximate value y₂ of the interval frequency in the second interval is calculated through an expression (1) representing this quadratic curve,

$${y}_{2} = 6 \frac{F}{{( ɛ N - 1 )}^{2}} ( 1 - \frac{1}{ɛ N - 1} ) + \frac{{y}_{n}}{ɛ N - 1} ( \frac{3}{ɛ N - 1} - 2 ) + {y}_{1} ( 1 \frac{4}{ɛ N - 1} + \frac{3}{{( ɛ N - 1 )}^{2}} ) \qquad Λ ( 1 )$$

If the calculated value is negative, the value is set to zero. The expression (1) is derived by acquiring coefficient values satisfying the condition (1, y₁), (εN, yₙ), and the integral value F from x=1 to εN in the general expression of the quadratic curve.

An example will be specifically described. In the values shown in FIG. 2C, since the error estimating value Δ for the value D1 is equal to zero, the approximate process is performed for the frequency. First, the first interval frequency y₁=5 is subtracted from the frequency count f=1500 to acquire a value 1495. This is the frequency count f in the number εN−1 of intervals from 1 to εN−1, in other words, the (N−1/ε) pieces of data in a cycle #2.

Next, the data value D1 is associated with the first interval frequency y₁=5, the final interval frequency yₙ=50, the frequency count f=1500, and εN=100. Thus, those values are substituted for the expression (1) to store the resulting value y₂=3.95≈4 as the approximate value of the first interval frequency y₁ in the new cycle b2. Since the error estimating value Δ related to the value D2 is not equal to zero, a value 10−1=9 is stored as the error estimating value Δ through a Δ subtraction process.

This process results in the frequency information related to each value stored in the sketch memory 36, as shown in FIG. 2D. This means that the process has finished in the intervals 1 to εN−1 of the cycle b2. In the cycle b2, the data in the interval εN are processed. The first interval frequency is calculated as described above to result in finishing the process before the interval εN−1 in a certain cycle. Therefore, the next interval is processed to result in finishing the process for the N pieces of data in this cycle.

Note that, in the frequency information addition process of the next interval, the value stored as the error estimating value Δ is always equal to a value εN−1.

As described above, the network analyzer 10 in this embodiment can continue an occurrence frequency arithmetic process for the first interval from the N-th data to extract the result through the search/extraction processor 30 each time the process was completed for the number 1/ε of data. The network analyzer 10 can extract the frequency information related to the value having the frequency count f equal to or more than a value (s−ε)N left in the sketch memory 36 by the extraction processor 30.

Returning to FIG. 6, after the subtraction and frequency approximate processes, it is determined whether or not all the frequency information was processed (Substep SS18). If the process is not finished (NO), the step returns to the acquisition Substep SS10 for the frequency information. If the process is finished (YES), the step progresses to the return to finish the occurrence frequency arithmetic process for the first interval.

The extraction processor 30 processes the search/extraction to output the acquired result on a display monitor, not shown.

In the network analyzer 10 of the instant embodiment, the frequency arithmetic processor 28 of the arithmetic processor 12 calculates the occurrence frequency in the first interval, thereby processing the frequency information in the next cycle to store this information in the sketch memory 36. This needs neither the overlap of the sketch memory 36 for each cycle nor the parallel processing for the same processes. The result from processing the N pieces of data can be extracted each time the 1/ε pieces of data have been processed. At this time, the frequency count f in the first to (εN−1)-th intervals shifted by one interval is calculated and the second interval frequency y₂ as the first interval frequency in the next interval is appropriately calculated based on the expression of the quadratic curve derived from the first interval frequency y₁, the final interval frequency yₙ, and the frequency count f, and the resulting value is subtracted from the frequency count f. Thereby, the occurrence frequency in the first interval of the previous cycle can be excluded from the next cycle. This can provide the more accurate counting process and statistical process to extract the more accurate result.

When data for starting the process in each cycle are shifted by the intended number w equal to or less than 1/ε of data to perform the counting process in each cycle in parallel as described above, the overlap in the process and the memory space is only for the 1/(εw) pieces of data. This can extract the result in a shorter time interval. The parallel processes would require the N/w-fold memory space and data processing capacity if the processes were not performed in accordance with this embodiment. Compared to this, the instant embodiment consumes only the 1/(εN)-fold memory space and processing time. Therefore, the larger value εN, the more reduced the memory space and the more improved the data processing capacity.

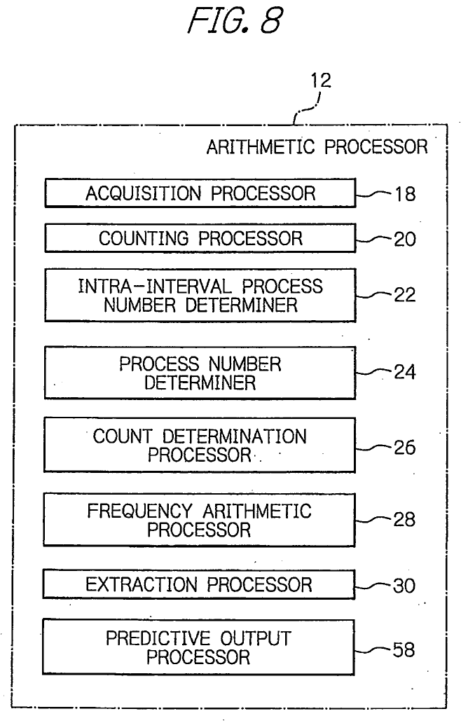

Next, an alternative embodiment will be described of the statistical processing apparatus in accordance with the present invention. Similar components and elements are designated with identical reference numerals and repetitive descriptions thereon will be omitted. The arithmetic processor 12 of this alternative embodiment includes, as shown in FIG. 8, a predictive output processor 58 in addition to the components of the previous embodiment.

The predictive output processor 58 has a function to process, before updating the frequency information by the occurrence frequency arithmetic process for the first interval, the pieces of data equal to or more than the value N to estimate the rate of change in occurrence frequency, and to calculate the trend of change in occurrence frequency for each value to generate warning information based on the resulting trend. The predictive output processor 58 estimates the rate of change in occurrence frequency to calculate the trend of change in occurrence frequency for each data, and outputs the generated warning information to a display monitor or a speaker, not shown, based on the resulting trend to inform a user of the warning information.

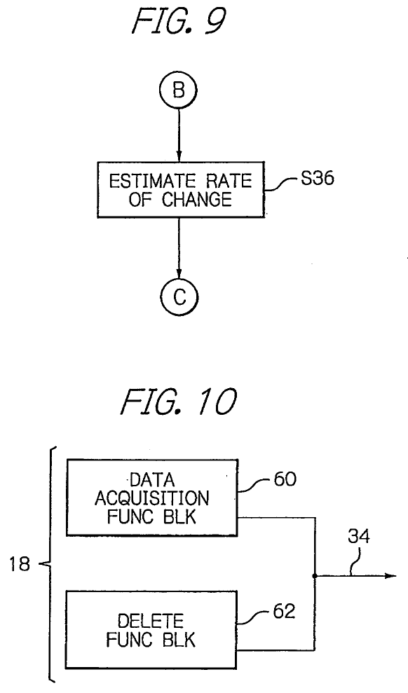

The operation of the instant alternative embodiment is simply illustrated in FIG. 9. The instant alternative embodiment differs in operation from the previous embodiment in that a rate-of-change estimation process is provided between the connectors B and C. Thus, as seen from the connection of the control flow, the rate-of-change estimation process is performed before the update of the frequency information by the occurrence frequency arithmetic process for the first interval.

In the rate-of-change estimation process, the predictive output processor 58 processes the data equal to or more than the value N to estimate the rate of change in occurrence frequency, and calculates the trend of change in occurrence frequency for each value to generate the warning information based on the resulting trend (Step S36).

In the predictive output processor 58, the derivative value of the quadratic curve for the expression (1) described earlier is calculated through an expression (2):

$${y}_{n}^{′} = 2 \frac{{y}_{1}}{ɛ N - 1 - Δ} + \frac{{y}_{n}}{ɛ N - 1 - Δ} - 6 \frac{F}{{( ɛ N - 1 - Δ )}^{2}} \qquad Λ ( 2 )$$

The derivative value y′ₙ is calculated as the rate of change estimated in the εN-th interval as the final interval.

At this time, the present alternative embodiment differs from the previous embodiment by the presence of the case of the error estimating value Δ>0. In this case, the estimated value of the rate of change will be calculated on the basis of the frequency count f counted from the (Δ+1)-th, in other words, b-th interval instead of the first interval. In addition, if Δ>εN−2, then the approximate process for the quadratic curve cannot be performed to disable the estimated value of the rate of change from being calculated. Therefore, the rate of change will not be estimated.

The predictive output processor 58 determines whether or not a predetermined condition is satisfied on the basis of calculating the estimated value of the rate of change. For example, in order to monitor the occurrence frequency equal to or higher than a predetermined value, it is determined whether or not the frequency count f has a possibility of exceeding the predetermined value based on the calculated rate of change in the predetermined number of data pieces ahead. In the predictive output processor 58, any condition can be defined so as to warn of the prediction when the calculated rate of change is determined to have the possibility equal to or higher than a predetermined value.

With reference to FIG. 2C as an example, the data value D1 is associated with the first interval frequency y₁=5, the final interval frequency yₙ=50, the frequency count f=1500, and εN=100, substituting these values for the expression (2) to acquire 5.17 by calculating the estimated value of the rate of change. The data value D2 is associated with the first interval frequency y₁=15, the final interval frequency yₙ=2, the frequency count f=720, and εN=100, substituting these values for the expression (2) to acquire −0.18 by calculating the estimated value of the rate of change.

Now, in the predictive output processor 58, for example, a condition is defined such as to give warning when the frequency count f has a possibility of exceeding a threshold value of 1550 within the twenty intervals ahead. Since the estimated value of the rate of change for the value D1 is equal to 5.17, the frequency count f may increase to 5.17×20=103.4 in the twenty intervals ahead. In this case, since 1500+103.4=1603.4, a threshold value of 1550 is estimated to be exceeded. Therefore, the predictive output processor 58 generates the warning information.

It is noted that the estimated value of the rate of change for the value D2 is equal to −0.18 to be on a decreasing trend. The frequency count f is unlikely to exceed the threshold value of 1550. Therefore, the predictive output processor 58 does not generate the warning information.

In the instant alternative embodiment, the predictive output processor 58 can calculate the rate of change in occurrence frequency for the εN-th interval as the final interval in the N pieces of data through a derivative value of the above-described quadratic curve based on the first interval frequency y₁, the final interval frequency yₙ, and the frequency count f for each value stored as the frequency information in the sketch memory 36, thereby estimating an increasing or decreasing trend of the occurrence frequency for each value.

Then, the network analyzer 10, when determining that the occurrence frequency has a possibility of increasing to approximation of the threshold value based on the resulting trend of the occurrence frequency, can generate the warning information based on the predetermined condition for an increase in the occurrence frequency to previously inform an operator of the warning. This can further improve the reliability of analysis of the occurrence frequency.

In the instant alternative embodiment, the relationship between the first interval frequency y₁, the final interval frequency yₙ and the frequency count f may be defined by a quadratic curve to calculate the occurrence frequency for the second interval corresponding to the first one of the intervals shifted by one interval. However, other curves may be used for the approximation instead of a quadratic curve. One of other preferred curves is based on, for example, a model of change in occurrence frequency.

The network analyzer 10 in those two illustrative embodiments processes the data 56 acquired through the interface circuit 16. However, after storing the N pieces of data in the storage 14 temporarily, the arithmetic processor 12 may perform the various processes.

In addition, the network analyzer 10 updates the final interval frequency yₙ, thereby storing the counted occurrence frequency in one interval in the final interval frequency yₙ temporarily to update and reflect this resultant count to the frequency count f after the process for one interval. However, instead of this method in some cases, the update may be processed at the same time. Alternatively, the frequency count f may be updated in the process for each interval, and the final interval frequency yₙ may also be updated for only the final interval.

The network analyzer 10 is adapted to extract data appearing with the occurrence frequency equal to or higher than a predetermined value from time-serial data, and includes a statistical method. However, in an practical application, this analyzer may be used for part of a visualization device informing an operator of a predetermined warning message on the basis of data related to the high occurrence frequency for visual check by the operator based on the value, or for preprocessing before an expensive analyze process in order to restrict a processed object to data related to the high occurrence frequency.

Next, the improvement of the counting process will be described in the arithmetic processor 12 of the network analyzer 10 utilizing the statistical processing apparatus in accordance with the present invention. The arithmetic processor 12 receives time-serial data, and counts the occurrence frequency of data or a value such as an IP address appearing in the time-serial data.

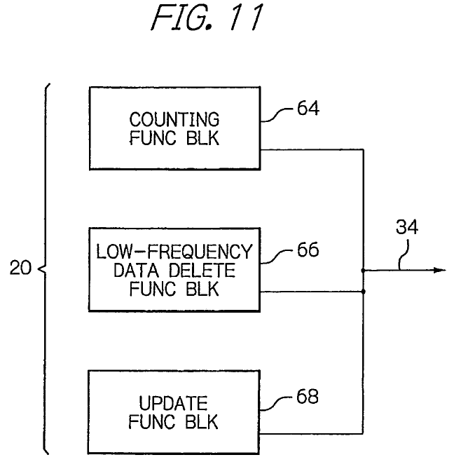

The data acquisition processor 18, as shown in FIG. 10, includes a data acquisition function block 60, and a delete function block 62. The data acquisition function block 60 has a function to acquire a value of data included in the received data. The delete function block 62 has a function to delete a count obtained in an initial stage from the counts stored in the storage 14.

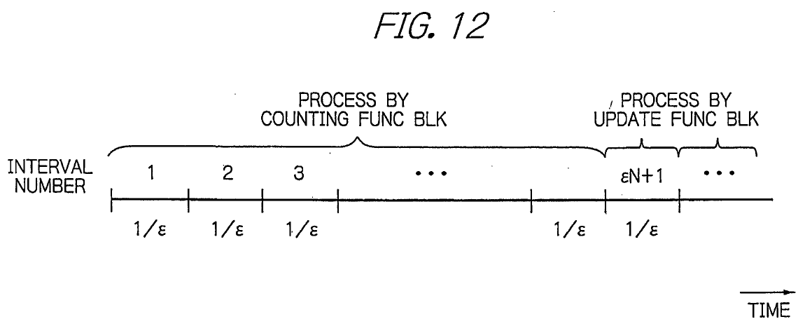

The counting processor 20, as shown in FIG. 11, includes a counting function block 64, a low-frequency data delete function block 66, and an update function block 68. The counting function block 64 has a function to receive the time-serial data to count the occurrence frequency of the same data or value, and send the resultant count to the storage 14 to store the latter.

The low-frequency data delete function block 66 has a function to delete the count having a low occurrence frequency from the counts stored in the storage 14. The update function block 68 has a function to consecutively receive, after the counting function block 64 counts a predetermined number of streams of data, an additional stream of data to store the resultant count in the storage 14. The update function block 68 additionally receives streams of data corresponding in number to one interval so as to update the count result. As described above, the previous count result stored in the storage 14 is updated with the additional count result.

Each function block may be implemented by hardware such as an electronics circuit, or by an arithmetic unit such as a CPU or a microcomputer, not shown, and software for defining the functions. These components may be entirely or partially formed into an integral structure.

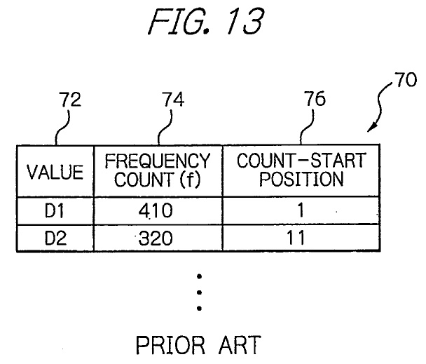

Reference will be made to FIG. 12 to describe an operation for dividing the stream of data to be counted in the counting function block 64. The counting function block 64, when counting a stream of data, sets an input buffer having its storage size predetermined in the storage 14 to input a stream of data into the buffer for counting.

In this case, the input buffer has its buffer size sufficient for counting the N pieces of data. In addition, for convenience of processing steps described below, the input buffer is divided into a plurality of segments. The division has three criterions.
(1) Before counting the stream of data, an allowable error is set to a value ε.
(2) The number of data pieces in one interval is set to a value 1/ε.
(3) The total number of intervals is represented by a value εN. Each interval has its interval number specific thereto, the number starting from one.

The counting function block 64 counts the first N pieces of data or values, in other words, the data or values in the first to εN-th intervals. The update function block 68 counts the data in the subsequent intervals.

In the counting process of the counting function block 64, the N pieces of data are inputted to the buffer. Thereafter, in the counting process of the update function block 68, the data are counted in every interval. Thus, subsequent count results will be acquired in each interval.

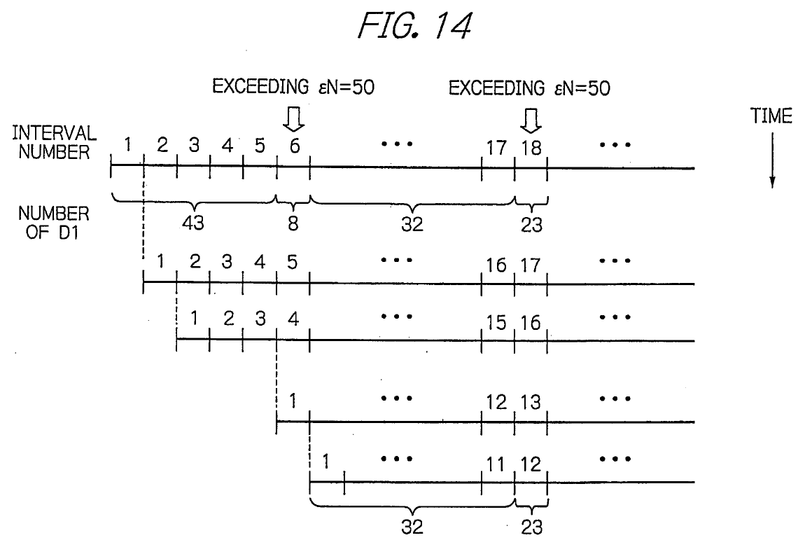

Now, the network analyzer 10 of the instant alternative embodiment will be simply compared with the counting algorithm described in the above-described Manku et al. FIG. 13 shows an example of containing count in a table form in the prior art. As seen from FIG. 12, the stream of data is divided into the plurality of intervals to be counted.

The table 70 shown in FIG. 13 includes a column 72 for “value”, a column 74 for “frequency count” as the occurrence frequency, and a column 76 for “count-start position”. The value of data appearing in a stream of data is contained in the column 72 for “value”. The occurrence frequency of the data in the column 72 for “value” is contained in the column 74 for “frequency count”.

In the column 76 for “count-start position”, the interval number is stored when the data in the column 72 for “value” first appears in the stream of data. The value in this column also represents the allowable error for counting the data. This is based on setting the number of data in one interval to (1/ε).

In this example, it is appreciated that the data whose “value=D1” first appears in the interval of the “interval number=1”, and is counted 410 times until this moment. Similarly, it is appreciated that the data of which the “value=D2” first appears in the interval of the “interval number=10”, and is counted 320 times until this moment.

In this prior art, the data is deleted as the low-frequency data having its occurrence frequency low when the count result of this data satisfies an expression (3):

frequency count f+count-start position≦current interval number. (3)

This keeps only the data having its occurrence frequency high which is considered to be important, thus intending to reduce the memory space.

However, in this prior art, since the capacity of the input buffer is set such as to correspond to the N pieces of data, other applications utilizing count results are kept waiting until finishing the counting for the N pieces of data. This is problematic in applications that need to obtain count results on or almost real-time basis.

Thus, in the network analyzer 10 of the instant alternative embodiment, a method is proposed for consecutively updating count results each time having finished the count for the first N pieces of data. Well, the consecutive updating of count results would cause the population parameter of the counts to change. Therefore, the expression (3) based on the population parameter corresponding to the value N could not be applied to the network analyzer 10 without modification. Thus, the network analyzer 10 is proposed which is adapted to frequently update the allowable error range to enable the expression (3) to be applied.

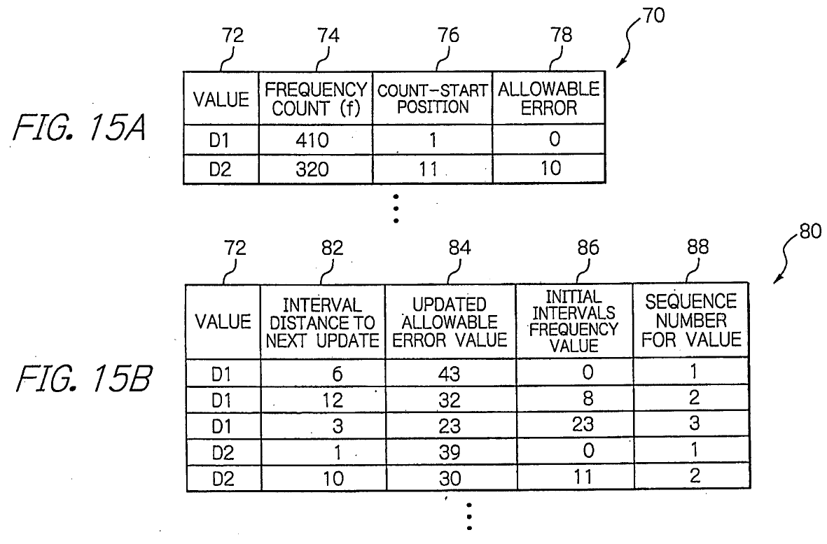

Operation of the instant alternative embodiment will be described. FIG. 14 shows a counting process in the counting function block 64. The counting function block 64, when counting the occurrence frequency of data in the inputted stream of data, stores information when the occurrence frequency exceeds a predetermined threshold value in the sketch memory 36 of the storage 14, together with the occurrence frequency. For example, the predetermined threshold value is set to “εN=50”. This predetermined threshold value is a criterion for a new allowable error.

The counting function block 64, when counting the occurrence frequency for the data of “value=D1”, records the current interval number in its storage format in the sketch memory 36 each time the occurrence frequency exceeds the predetermined threshold value of 50.

In this example, at the “interval number=6”, the frequency count f exceeds the value 50. After further progressing the eleven intervals, the frequency count f exceeds 50 again at “interval number=17”. The counting function block 64 stores these interval numbers in the sketch memory 36 in order to specify these interval numbers later.

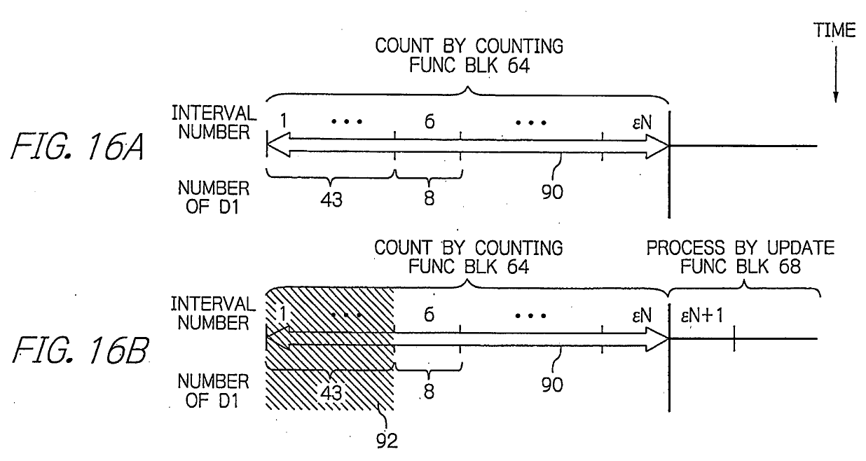

Next, reference will be made to FIGS. 15A and 15B to describe a storing process into the sketch memory 36. The sketch memory 36, as shown in FIG. 15A, includes a count result table 70. The count result table 70 contains resultant counts for a stream of data. In addition to the items of the count result table 70 shown in FIG. 13, a column 78 for “allowable error” is newly provided. In the prior art, the allowable error is constant with the progress of counting. However, in the present alternative embodiment, the allowable error may change consecutively as described below. In the alternative embodiment, in order to consecutively follow such a change, the column 78 for “allowable error” is provided.

The value in the first line of the column 78 for “allowable error” is zero. The reason for this is that, until performing the steps described below, the allowable error does not change, but is equal to the value in its initial state, i.e. in the start position for the statistical calculation.

The sketch memory 36, as shown in FIG. 15B, also includes a threshold value position table 80. The threshold value position table 80 is prepared to consecutively store a position, shown in FIG. 14, when a resultant count exceeds the predetermined threshold value, which is equal to 50 in the example. The threshold value position table 80 includes the column 72 for “value”, a column 82 for “interval distance to next update”, a column 84 for “updated allowable error value”, a column 86 for “initial intervals frequency value”, and a column 88 for “sequence number for value”.

The value of data appearing in a stream of data is contained in the column 72 for “value”. The column 82 for “interval distance to next update” contains the number of intervals between the previous and next timings where the resultant count exceeds the predetermined threshold value (50). The column 84 for “updated allowable error value” contains the resultant count of the intervals from the previous timing right before the next timing where the resultant count exceeds the predetermined threshold value (50).

Meanwhile, in the first interval, i.e. the interval #1, or when the value is contained in each column of the threshold value position table 80 in response to exceeding the predetermined threshold value and then the resultant count exceeds the predetermined threshold value in the same interval, the column 82 for “interval distance to next update” contains zero, and the column 84 for “updated allowable error value” contains the resultant count until the current interval.

The column 86 for “initial intervals frequency value” contains the frequency count f of the data in only the interval where the resultant count has exceeded the predetermined threshold value (50). The column 88 for “sequence number for value” contains a sequence number, which is newly given each time the resultant count exceeds the predetermined threshold value (50) in order to specify the record order for the data having the same value in the column 72 for “value” for the purpose of convenience.

About the data in the first and second lines in FIG. 15B, operation will be described on the basis of the value in the example shown in FIG. 13. In this example, since the resultant count first exceeds the predetermined threshold value (50) in the sixth interval after starting the count from the first interval, the first line is set to “interval distance to next update=6”. The “updated allowable error value” is set to “updated allowable error value=43” since the total count result until the previous interval is equal to 43. The “initial interval frequency value” is also set to “initial interval frequency value=0” since the threshold value position table 80 does not contain data related to the value “D1”.

It is appreciated that the next timing when the resultant count exceeds the value of 50 is further subsequent to the twelve intervals from the second line in the threshold value position table 80. Therefore, the second line is set to “interval distance to next update=12”. The “updated allowable error value” is set to “updated allowable error value=32” since the resultant count until the previous interval is equal to 32. The “initial intervals frequency value” is set to “initial intervals frequency value=8” since the occurrence frequency of the value “D1” is equal to eight in only the previous interval where the predetermined threshold value (50) is exceeded, namely, the interval having an interval number=5. In addition, since the first and second lines are related to the position of the threshold value for the same “value=D1”, the value in the column 88 for “sequence number for value” is given by sequentially incrementing the number from one by one.

The “allowable counting error” in the instant alternative embodiment corresponds to the value εN. The “updated allowable counting error” corresponds to the value in the column 84 for “updated allowable error value” of the threshold value position table 80.

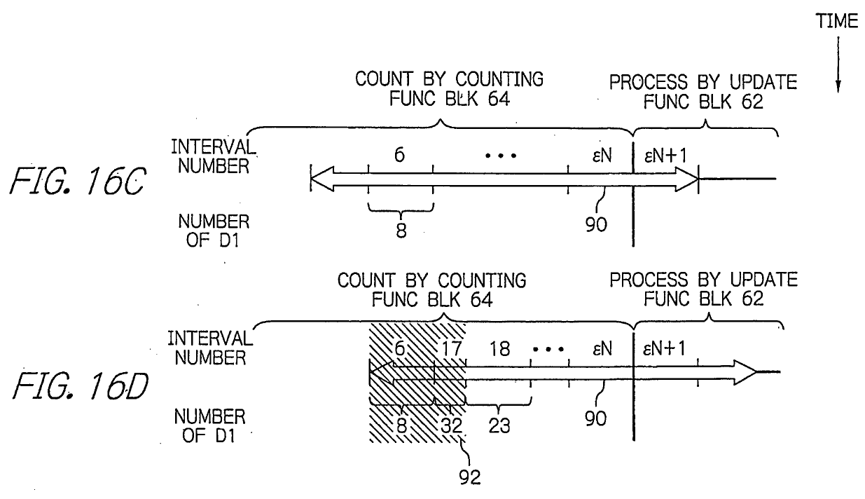

Next, reference will be made to FIGS. 16A to 16D to describe processing steps in the delete function block 62. An arrow 90 indicates a region to be counted in each step.

(1) Counting process for the number N of the data The counting function block 64, as shown in FIG. 16A, individually counts the same data or values in the first N pieces of data or values to store a resultant count in the storage 14. It is assumed that the resultant count in this counting is obtained which is similar to that described with reference to FIGS. 14, 15A and 15B.

(2) Delete process for an initial count
(2.1) The delete function block 62 entirely deletes a count result for the value D1 in a shaded region 92 in FIG. 16B, i.e. the intervals 1 to 5.
(2.2) The count result for the value D1 includes an error, equal to a resultant count, caused by deleting the count result. Thus, the threshold value position table 80 described with reference to FIG. 15B is used to update the allowable error related to the data or value D1 with the same value as the resultant count that has been deleted.

(3) Shifting process for intervals by one interval As shown in FIG. 16C, after the region to be counted 90 is forward shifted by one interval, the update function block 68 counts the data or values. In this case, the data or values in the interval having its “interval number=εN” are counted. In a similar way thereafter, the update function block 68, while forward shifting the intervals by one interval, sequentially stores the resultant count in the storage 14. Other applications may acquire a count result that is consecutively stored in each interval.

(4) Delete process for the initial count Once the left edge of the region to be counted reaches the interval 6 where the resultant count for the value D1 exceeds 50, the delete function block 62 performs the following processes.
(4.1) The delete function block 62 entirely deletes the count result for the value D1 in a shaded region 92 shown in FIG. 16D, i.e. the intervals 6 to 17.
(4.2) The count result for the value D1 includes an error, equal to the resultant count, caused by deleting the count result. Thus, the threshold value position table 80 described with reference to FIG. 15B is used to update the allowable error related to the data or value D1 with the same value as the resultant count that has been deleted.

In a similar way thereafter, each time the left edge of the region to be counted reaches the interval where the resultant count for the value D1 exceeds the value of 50, the delete function block 62 deletes the old count, and updates the value of the allowable error 78 for the value D1 in the count result table 70 with the value in the first line of the column 86 for “initial intervals frequency value” in the threshold value position table 80.

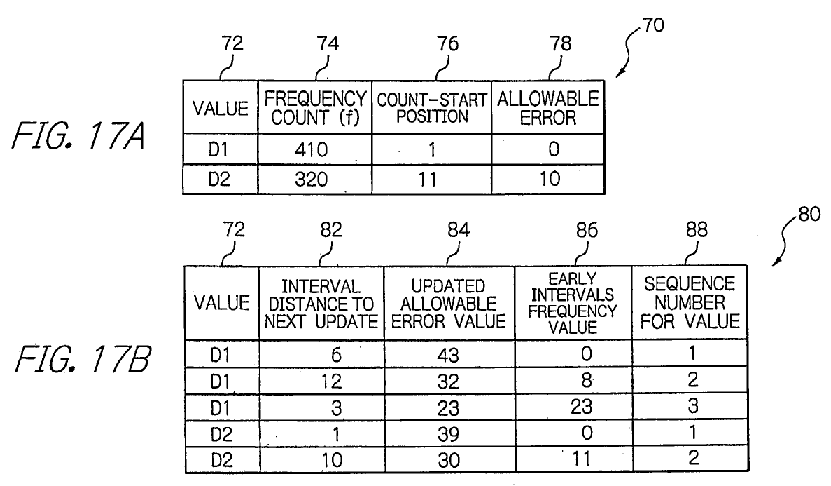

Next, reference will be made to FIGS. 17A to 17D to describe steps for using the values contained in the threshold value position table 80. These values are the same as in FIG. 15B.

FIGS. 17A and 17B show the state before the delete process shown in FIG. 16B. The delete function block 62 checks the value of the column 76 for “count-start position” in the count result table 70 in each boundary of the interval to search for the value 72 equal to “1” as the value of this column. In this case, since the value D1 appears from the interval #1, the value of the column 76 for the value D1 is “1”.

Next, the delete function block 62 searches the data in the threshold value position table 80 for “value=D1” to further acquire the data having the smallest “sequence number for value”. This acquisition condition is satisfied by the data in the first line in FIG. 17B. If such data are not found, the delete function block 62 deletes the count result for “D1” from the count result table 70 since it is represented that the resultant count of “value=D1” has an allowable error less than “εN=50”.

Next, the delete function block 62 uses the data in the first line in FIG. 17B to update the data related to the value D1 in the count result table 70. Specifically, the following processes are performed.

(1) The delete function block 62 subtracts the sum of the values of the column 84 for “updated allowable error value” and the column 86 for “initial intervals frequency value” in the threshold value position table 80 from the value of the column 74 for “frequency count” in the count result table 70. This means the delete of the count result until the interval #6, and corresponds to the process in the step (2) shown in FIG. 16B.

(2) The delete function block 62 updates the value of the column 78 for “allowable error” in the count result table 70 with the value of the column 84 for “updated allowable error value” in the threshold value position table 80. However, if the value of the column 82 for “interval distance to next update” is zero, the value of the column 78 for “allowable error” is updated with zero. This is a compensation process associated with the delete of the count result until the interval #6, and considers the error, caused in the count result, corresponding to the amount of the delete.

(3) The delete function block 62 updates the value of the column 76 for “count-start position” in the count result table 70 with a value calculated by subtracting one from the value of the column 82 for “interval distance to next update” in the threshold value position table 80 shown in FIG. 17B.

However, if the value of the column 82 for “interval distance to next update” is zero, the value of the column 76 for “count-start position” is left as one not to be updated. This is a process for preparing for the step (4) shown in FIG. 16D. Thereafter, the update function block 68 subtracts one from all the values of the column 76 for “count-start position” in the count result table 70 each time the interval to be counted progresses by one interval, and performs the delete process similar to the above-described steps (1) and (2) for the data such that the value of the column 76 is one, at this moment.

For example, the next delete process for the value D1 is performed when the value of the column 76 for “count-start position” turns to one, in other words, when the five intervals have been passed, i.e. at the timing in the step (4) shown in FIG. 16D.

Next, FIGS. 17C and 17D show the state of each table after the delete function block 62 finishes the above-described processes. The count result table 70, as shown in FIG. 17C, has the data in the first line as the old count result deleted. These data in the first line are calculated through the data in the first line of the threshold value position table 80 shown in FIG. 17B. The value of the column 78 for “allowable error” is updated with the column 84 for “updated allowable error value” in FIG. 17B. Associated with this update, the threshold value position table 80, FIG. 17B, has the data in the first line deleted as shown in FIG. 17D.

Thereafter, the delete function block 62 repeats the same steps each time reaching the boundary of the interval. Thereby, the count result table 70 has the data of the old count result deleted to hold only the new data, and has the value of the column 78 for “allowable error” updated with the value corresponding to the amount of the deleted data. This can save the memory space, and maintain a certain level of accuracy in counting results.

The delete of the old count result is based on the fact that, the older the data, the less important the data in order to statistically know the current state when counting a stream of data under the circumstances where new data always reach the network analyzer 10.

With respect to the example shown in FIGS. 17A to 17D, the data having the value of the column 76 for “count-start position” equal to one appears in the initial stage of counting. Therefore, the delete of a certain number of these data pieces is considered not to have much effect on statistically knowing the current state of the data.

The network analyzer 10, in addition to performing the delete processes by the delete function block 62 described with reference to FIGS. 16A to 16D and 17A to 17D, deletes the data having its occurrence frequency lower from the count result table 70 through the expression (3) in the low-frequency data delete function block 66, similar to the prior art described in Gurmeet Singh Manku, et al.

These double delete processes can effectively reduce the space of consumed memory. In addition, since the update function block 68 consecutively updates the data, count results can be acquired at a time interval required to update data in one interval.

The operational steps of the network analyzer 10 in the instant alternative embodiment will generally be summarized to read as follows.

(1) The counting function block 64 sets the first N pieces of data in the buffer to count the data, and stores a resultant count in the count result table 70 to consecutively set the value in the threshold value position table 80.

(2) After the counting function block 64 counts the N pieces of data, the delete function block 62 determines whether or not the old data in each boundary of the interval are to be deleted by determining whether or not the value of the column 76 for “count-start position” is equal to unity, and performs the delete process described with reference to FIGS. 16A to 16D.

(3) The low-frequency data delete function block 66 deletes the low-frequency data satisfying the condition of the expression (3) in each interval.

(4) After the counting function block 64 counts the N pieces of data, the update function block 68 stores the resultant count of the additional data in each interval, in the count result table 70 and the threshold value position table 80.

In the instant alternative embodiment, the storage format for the count results is not to be restricted to the table format as shown in FIGS. 15A and 15B, but any storage formats such as a listing format may be used.

As described above, in the network analyzer 10, the counting function block 64 records the interval number when the occurrence frequency exceeds the predetermined threshold value εN=50 in the threshold value position table 80, and the delete function block 62, after counting the N pieces of data, references to the threshold value position table 80 in each boundary of the interval to delete the count result obtained in the initial stage under the predetermined condition. This enables the network analyzer 10 to save the memory space for storing count results.

In the network analyzer 10, since count results obtained in the initial stage is not so important in order to statistically know the latest state, a certain level of accuracy in counting results can be maintained even if these delete processes are performed.

In addition, since the delete function block 62 updates the value of the column 78 for “allowable error” in the count result table 70 with the column 84 for “updated allowable error value” in the threshold value position table 80, in other words, a count result immediately before exceeding the allowable error as the predetermined threshold value when deleting the count result obtained in the initial stage, the counting can maintain an error within a certain range and hence its accuracy even if the old count result is deleted.

After the counting function block 64 counts the N pieces of data, the update function block 68 consecutively stores a count result in the count result table 70 each time counting the data in one interval. This enables other applications to acquire count results on or almost real-time basis. The network analyzer 10 does not keep an application consecutively requiring count results waiting until finishing the counting, which can improve the processing speed.

In addition, the low-frequency data delete function block 66 deletes data having its statistical occurrence frequency low from the count results, which can reduce the memory space for storing count results.

Now, a further alternative embodiment will be described in accordance with the present invention. The network analyzer 10 has a function to collect communication packets streaming over a telecommunications network, count certain information in the packets such as send/receive addresses, store such results, and make an analysis through a statistical process based on the stored results.

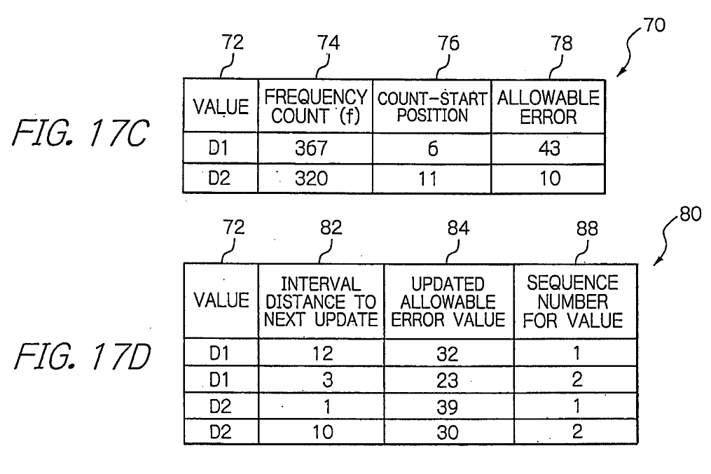

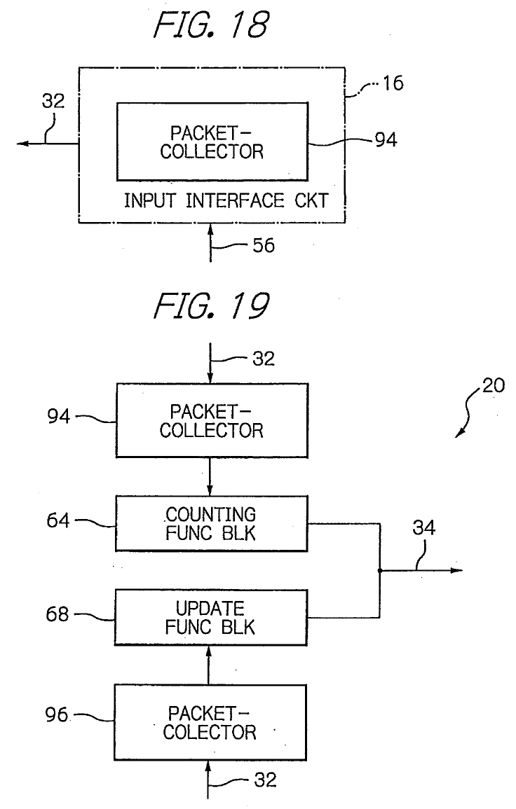

The network analyzer 10, as shown in FIG. 1, includes the input interface circuit 16. The input interface circuit 16 may include a packet collector 94, as shown in FIG. 18. The counting processor 20 of the arithmetic processor 12 may include the packet collector 94 and another packet collector 96, as shown in FIG. 19, which may be connected to the counting function block 64 and the update function block 68, respectively.

The packet collectors 94 and 96 are connected to a network, and have a function to collect the communication packets, extract information about objects to be counted such as send/receive addresses, and output the information. The packet collectors 94 and 96 output the extracted send/receive addresses in the packets to the counting function block 64 and the update function block 68, respectively. Particularly, in the counting processor 20, the packet collector 94 collects the first N send/receive addresses, and then the packet collector 96 collects the subsequent send/receive addresses. Since processes after collecting the packets may be similar to the previous embodiments, a repetitive description thereon is omitted.

Since there are many send/receive addresses of communication packets over a telecommunications network, the large memory space is needed in order to count these addresses. Thus, the network analyzer 10 in accordance with the previous embodiments can be applied to effectively count the send/receive addresses using the small memory space.

The above-described embodiments involve the algorithm for counting the same values appearing on streams of data, for example, the same send/receive addresses. However, objects to be counted is not to be restricted to the same data, but values which are “equivalent” may be counted if the values match the purpose of the counting.

For example, in the network analyzer 10 of the previous alternative embodiment, when it is necessary to count send/receiver packets related to the same network address, the counting function block 64 may count the packets by considering the addresses such that the same value is acquired by subnet masking, as the same value.

The entire disclosure of Japanese patent application Nos. 2008-7359 and 2008-53195 filed on Jan. 16 and Mar. 4, 2008, respectively, including the specification, claims, accompanying drawings and abstract of the disclosure, is incorporated herein by reference in its entirety.

While the present invention has been described with reference to the particular illustrative embodiments, it is not to be restricted by the embodiments. It is to be appreciated that those skilled in the art can change or modify the embodiments without departing from the scope and spirit of the present invention.

What is claimed is:

1. A statistical processing apparatus for setting an number of allowable errors represented by a reciprocal of an allowable error rate to be set for a predetermined number of sets of supplied data as a number of intervals for delimiting the data, counting an occurrence frequency for a value of each of data pieces in one interval, deleting frequency information for the occurrence frequency lower than a predetermined occurrence frequency each time acquiring the frequency information based on counting, and acquiring the frequency information for the data through a statistical process, comprising:
a storage for storing the occurrence frequencies in entire intervals defined as all of the intervals, and first one and final one of the entire intervals as a set of the occurrence frequencies; and
an arithmetic processor for counting the occurrence frequency of the value while deleting the frequency information matching a comparison of the stored frequency information;
said arithmetic processor determining whether to estimate the occurrence frequency of the value in an interval next to the first interval for the value of the frequency information stored in said storage after counting the predetermined number of sets of data or after counting the value of the set of data in each interval,
said arithmetic processor being in response to true determination to store in said storage a value calculated by subtracting the occurrence frequency in the first interval from the estimated occurrence frequency as the occurrence frequency in the sets of data of a number, corresponding to the predetermined number minus one, of the intervals shifted by one interval,
said arithmetic processor estimating the occurrence frequency in the interval next to the first interval based on a set of occurrence frequencies to store the estimated occurrence frequency in said storage as the occurrence frequency of the first interval in the predetermined number of next sets of data shifted by one interval.

2. A statistical processing apparatus for setting an number of allowable errors represented by a reciprocal of an allowable error rate to be set for a predetermined number of sets of data in a stream of data supplied in one cycle period as a number of intervals for delimiting data, counting an occurrence frequency of a value for each data pieces in one interval, deleting frequency information for the occurrence frequency lower than a predetermined occurrence frequency each time acquiring the frequency information based on counting, and acquiring the frequency information for the data, comprising:
a storage for storing the occurrence frequencies in first one and final one of the intervals delimited for the sets of data, the occurrence frequency for counting the occurrence of each value of the data, and an error estimating value representing a count starting interval of the occurrence frequency for counting the occurrence of each value of the data as a set of frequency information related to counting; and
an arithmetic processor for searching said storage storing the frequency information of the value in the data having an occurrence rate equal to or higher than a predetermined occurrence rate in the cycle period, processing the frequency information in said storage through addition, delete and modification, setting, after processing the first set of data, the set of data shifted by one interval as a next cycle each time processing the data for one interval, and performing the addition, delete and modification for the frequency information of the value so as to search for and acquire the frequency information of the value in the data having the occurrence rate equal to or higher than the predetermined occurrence rate for the set of data of the next cycle;
said arithmetic processor including:
an acquisition processor for acquiring a value of the data included in a stream of data;
a counting processor for newly adding the frequency information for the acquired value in response to an absence of the value for the supplied data, and adding the occurrence frequency of the frequency information for the acquired value in response to a presence of the value to update the occurrence frequency;
an intra-interval process number determiner for counting a number of processes for the data from the first data in each interval to store the count in said storage, and to determine whether to reach an interval boundary based on the stored number of the processed data in the interval;
a process number determiner for counting the number of the processes for the data from the start of the processes to determine whether or not the number of sets of data less than the predetermined number has been processed on a basis of the number of the processed data stored in said storage;
a count determination processor for deleting the frequency information having the occurrence frequency lower than the predetermined occurrence frequency in the data for the number of the processed intervals based on the occurrence frequency of the value and the error estimating value in the set of data after processing the data acquired in one interval; and
a frequency arithmetic processor for adjusting the occurrence frequency by said counting processor based on the error estimating value of each value for the set of data in the first cycle stored in said storage, associated with an end of process of said counting processor and said count determination processor, determining whether to estimate the occurrence frequency of the value in an interval next to the first interval, storing, in response to true determination, a value calculated by subtracting the occurrence frequency in the first interval from the estimated occurrence frequency in said storage as the occurrence frequency in the sets of data for a number, corresponding to the predetermined number minus one, of intervals shifted by one interval, and estimating the occurrence frequency in the interval next to the first interval based on one set of occurrence frequencies to store the estimated occurrence frequency in said storage as the occurrence frequency of the first interval in the next sets of data for the predetermined number of intervals shifted by one interval,
said arithmetic processor consecutively processing inputted data treated as data inputted from the first data of the final interval in the next cycle.

3. The apparatus in accordance with claim 2, wherein said frequency arithmetic processor decrements the error estimating value by one in response to false determination for estimating the occurrence frequency in the next interval.

4. The apparatus in accordance with claim 2, wherein said arithmetic processor connects the occurrence frequencies in the first and final intervals to estimate the occurrence frequency in the next interval based on an expression of a quadratic curve representing an area formed by the occurrence frequencies in the first and final intervals.

5. The apparatus in accordance with claim 2, wherein said arithmetic processor estimates a rate of change in occurrence frequency of each value based on the occurrence frequencies in the first, final and entire intervals.

6. The apparatus in accordance with claim 5, wherein said arithmetic processor connects the occurrence frequencies in the first and final intervals to estimate a differential value in the final interval calculated through an expression acquired by differentiating a quadratic curve representing the area formed by the occurrence frequencies in the first and final intervals as the rate of change in occurrence frequency.

7. The apparatus in accordance with claim 2, wherein said arithmetic processor further includes an extraction processor for searching said storage for the frequency information having the occurrence rate equal to or higher than the predetermined occurrence rate to extract the frequency information after counting the predetermined number of sets of data and after counting the value of the set of data in each interval.

8. The apparatus in accordance with claim 2, wherein said acquisition processor includes:
a data acquisition function block for acquiring the value of the data included in the stream of data; and
a delete function block for deleting an entire or partial count result in an initial stage in response to attainment of the number of the streams of data inputted into a storage area of said storage to a maximum size of said storage area;
said counting processor including:
a counting function block for grouping a same value in the stream of data to count the occurrence frequency of the value in each group while entering the stream of data into said storage area;
a low-frequency data delete function block for deleting the frequency information having the occurrence frequency lower than the predetermined occurrence frequency in the individual groups; and
an update function block for additionally receiving the number of the streams of data corresponding to one of the interval to update the count result,
said delete function block updating an allowable counting error in the group where the count result is deleted with the count result of the group before the delete, thereby keeping counting errors before and after the delete within a range of the allowable counting error,
said counting function block storing a set of the count result and the number of allowable errors in the group in said storage.

9. The apparatus in accordance with claim 8, wherein said counting function block stores into said storage the count result until the interval before by one interval the interval where the occurrence frequency exceeds the number of allowable errors as an updated value of the number of allowable errors in each group,
said delete function block updating the number of allowable errors in the group where the count result is deleted with the updated value of the number of allowable errors.

10. The apparatus in accordance with claim 9, wherein said delete function block, in the group where the count result is deleted, subtracts the updated value of the number of allowable errors from the count result of the occurrence frequency in the update of the number of allowable errors with the updated value.

11. The apparatus in accordance with claim 10, wherein said statistical processing apparatus repeats processes of said delete function block, said low-frequency data delete function block and said update function block until an end of the stream of data,
said counting function block storing into said storage the number of the interval where the count result of the occurrence frequency exceeds the number of allowable errors,
said delete function block storing a set of the number of the interval stored in said storage and the count result in the group into said storage, in the update of the number of allowable errors, in the group where the count result is deleted, with the updated value of the number of allowable errors.

12. The apparatus in accordance with claim 11, wherein said update function block subtracts one from the number of the interval stored into said storage by said delete function block each time processed by said update function block,
said delete function block performing a process thereof only where the number of the interval is one.

13. The apparatus in accordance with claim 8, wherein said low-frequency data delete function block acquires a sum of the count result and the number of allowable errors in the individual groups to delete the count result of the group where the acquired sum is equal to or less than the number of the intervals.

14. A statistical processing method for setting an number of allowable errors represented by a reciprocal of an allowable error rate to be set for a predetermined number of supplied sets of data as a number of intervals for delimiting the data, counting an occurrence frequency for a value of each of data pieces in one interval, deleting frequency information for the occurrence frequency lower than a predetermined occurrence frequency each time acquiring the frequency information based on counting, and acquiring the frequency information for the data through a statistical process, comprising:
a first step of determining whether to require to estimate the occurrence frequency in an interval next to a first interval in a divided set of data for each value of the frequency information stored in a storage after counting for the set of data and after counting the value in each interval; and
a second step of storing the occurrence frequency calculated by subtracting the occurrence frequency in the first interval from the acquired occurrence frequency for the set of data in the storage as the occurrence frequency through a counting process in the data of a number, corresponding to the predetermined number minus one, of the intervals shifted by one interval based on the occurrence frequency in the first interval, the occurrence frequency in the final interval in the divided set of data, and the occurrence frequency in the sets of data stored in the storage as the frequency information where a determination in said first step is true, and estimating the occurrence frequency in the next interval to store the estimated occurrence frequency in the storage as the occurrence frequency of the first interval in a next set of data shifted by one interval.

15. The method in accordance with claim 14, wherein the occurrence frequencies in the first and final intervals are connected to each other to estimate the occurrence frequency in the next interval based on an expression of a quadratic curve representing an area formed by the occurrence frequencies in the first and final intervals.

16. The method in accordance with claim 14, further comprising a third step of estimating a rate of change in occurrence frequency of each value based on the occurrence frequencies in the first, final and entire intervals.

17. The method in accordance with claim 16, wherein said third step connects the occurrence frequencies in the first and final intervals to each other to estimate a differential value in the final interval calculated through an expression acquired by differentiating a quadratic curve representing the area formed by the occurrence frequencies in the first and final intervals as the rate of change in occurrence frequency.

18. The method in accordance with claim 14, wherein the storage is searched for the frequency information having the occurrence rate equal to or higher than the predetermined occurrence rate to extract the frequency information after the counting for the set of data and after counting the value in each interval.

19. The method in accordance with claim 14, wherein said second step comprises:
a fourth step of grouping the data having a same value in a stream of data to count the occurrence of the data,
a fifth step of deleting an entire or partial count result in an initial stage where the number of the stream of data inputted into a storage area of the storage attains to a maximum size of the storage area;
a sixth step of deleting a group where the counted occurrence frequency is lower than the predetermined occurrence frequency as a threshold value; and
a seventh step of additionally receiving a number of the data in a stream of data corresponding to one of the intervals to update the count result,
said first step storing a set of the count result and the number of allowable errors in each group in the storage,
said second step updating the number of allowable errors in the group where the count result is deleted with the count result of the group before the delete, thereby keeping counting errors before and after the delete within a range of the number of allowable errors.

20. The method in accordance with claim 19, wherein said fourth step stores into the storage the count result until the interval before by one interval the interval where the count result of the occurrence frequency exceeds the number of allowable errors as an updated value of the number of allowable errors in each group,
said fifth step updating the number of allowable errors in the group where the count result is deleted with the updated value of the number of allowable errors.

21. The method in accordance with claim 20, wherein said fifth step, when updating the number of allowable errors in the group where the count result is deleted with the updated value of the number of allowable errors, subtracts the updated value of the number of allowable errors from the count result of the occurrence frequency in the group.

22. The method in accordance with claim 20, wherein said fifth, sixth and seventh steps are repeated until an end of the stream of data,
said fourth step storing the number of the interval where the count result of the occurrence frequency exceeds the number of allowable errors into the storage,
said fifth step storing a set of the number of the interval stored into the storage in said first step and the count result in the group into the storage, in the update of the number of allowable errors in the group where the count result is deleted, with the updated value of the number of allowable errors.

23. The method in accordance with claim 22, wherein one is subtracted from the number of the interval stored into the storage in said fifth step after each update in said seventh step, and then said fifth step is performed only where the number of the interval is one.

24. The method in accordance with claim 19, wherein said sixth step acquires a sum of the count result and the number of allowable errors in an individual groups to delete the count result of the group where the acquired sum is equal to or less than the number of the intervals.

25. The method in accordance with claim 14, wherein said method is performed by a computer.

26. The method in accordance with claim 15, wherein said method is performed by a computer.

27. The method in accordance with claim 16, wherein said method is performed by a computer.

28. The method in accordance with claim 17, wherein said method is performed by a computer.

29. The method in accordance with claim 18, wherein said method is performed by a computer.

30. The method in accordance with claim 19, wherein said method is performed by a computer.

31. The method in accordance with claim 20, wherein said method is performed by a computer.

32. The method in accordance with claim 21, wherein said method is performed by a computer.

33. The method in accordance with claim 22, wherein said method is performed by a computer.

34. The method in accordance with claim 23, wherein said method is performed by a computer.

35. The method in accordance with claim 24, wherein said method is performed by a computer.
